(19) United States
(12) Patent Application Publication
(10) Pub. No.: US 2026/0095925 A1
(43) Pub. Date: Apr. 2, 2026

(54) SYNCHRONIZATION SIGNAL BLOCK (SSB) DESIGN FOR MACHINE TYPE COMMUNICATION (MTC) AND NON-MTC UES

(71) Applicant: QUALCOMM Incorporated, San Diego, CA (US)

(72) Inventors: Le LIU, San Jose, CA (US); Yan ZHOU, San Diego, CA (US); Jing JIANG, San Diego, CA (US); Alberto RICO ALVARINO, San Diego, CA (US); Wei YANG, San Diego, CA (US); Gabi SARKIS, San Diego, CA (US); Kangqi LIU, San Diego, CA (US); In-Soo KIM, San Diego, CA (US)

(21) Appl. No.: 18/900,474

(22) Filed: Sep. 27, 2024

(51) Int. Cl. H04W 72/30; H04W 48/16

(52) U.S. Cl. CPC H04W 72/30; H04W 48/16

(57) ABSTRACT

Methods, systems, and devices for wireless communications are described. A user equipment (UE) may monitor a first subset of a set of resources for a first portion of resource blocks of a synchronization signal block (SSB) based on a capability of the UE. The UE may monitor a second subset of the set of resources for a second portion of resource blocks of the SSB based on the capability of the UE. The first subset of the set of resources may be different from the second subset of the set of resources, the first subset of the set of resources may be allocated for one or more wireless devices having a different capability than the capability of the UE. A first part of a physical broadcast channel (PBCH) may be mapped to the first subset and a second part of the PBCH may be mapped to the second subset.

### FIELD OF TECHNOLOGY

The following relates to wireless communications, including synchronization signal block (SSB) design for machine type communication (MTC) and non-MTC UEs.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include monitoring a first subset of a set of resources for a first portion of resource blocks of a synchronization signal block (SSB) based on a capability of a UE, monitoring a second subset of the set of resources for a second portion of resource blocks of the SSB based on the capability of the UE, where the first subset of the set of resources is different from the second subset of the set of resources, the first subset of the set of resources allocated for one or more wireless devices having a different capability than the capability of the UE, where a first part of a physical broadcast channel (PBCH) is mapped to the first subset of the set of resources and a second part of the PBCH is mapped to the second subset of the set of resources, decode system information associating with the SSB based on the first subset of the set of resources and the second subset of the set of resources, and performing a cell acquisition procedure based on the system information.

A UE for wireless communications is described. The UE may include one or more memories storing processor executable code, and one or more processors coupled with the one or more memories. The one or more processors may individually or collectively be operable to execute the code to cause the UE to monitor a first subset of a set of resources for a first portion of resource blocks of a UEs based on a capability of a UE, monitor a second subset of the set of resources for a second portion of resource blocks of the SSB based on the capability of the UE, where the first subset of the set of resources is different from the second subset of the set of resources, the first subset of the set of resources allocated for one or more wireless devices having a different capability than the capability of the UE, where a first part of a PBCH is mapped to the first subset of the set of resources and a second part of the PBCH is mapped to the second subset of the set of resources, decode system information associate with the SSB based on the first subset of the set of resources and the second subset of the set of resources, and perform a cell acquisition procedure based on the system information.

Another UE for wireless communications is described. The UE may include means for monitoring a first subset of a set of resources for a first portion of resource blocks of a UEs based on a capability of a UE, means for monitoring a second subset of the set of resources for a second portion of resource blocks of the SSB based on the capability of the UE, where the first subset of the set of resources is different from the second subset of the set of resources, the first subset of the set of resources allocated for one or more wireless devices having a different capability than the capability of the UE, where a first part of a PBCH is mapped to the first subset of the set of resources and a second part of the PBCH is mapped to the second subset of the set of resources, means for decode system information associating with the SSB based on the first subset of the set of resources and the second subset of the set of resources, and means for performing a cell acquisition procedure based on the system information.

A non-transitory computer-readable medium storing code for wireless communications is described. The code may include instructions executable by one or more processors to monitor a first subset of a set of resources for a first portion of resource blocks of a UEs based on a capability of a UE, monitor a second subset of the set of resources for a second portion of resource blocks of the SSB based on the capability of the UE, where the first subset of the set of resources is different from the second subset of the set of resources, the first subset of the set of resources allocated for one or more wireless devices having a different capability than the capability of the UE, where a first part of a PBCH is mapped to the first subset of the set of resources and a second part of the PBCH is mapped to the second subset of the set of resources, decode system information associate with the SSB based on the first subset of the set of resources and the second subset of the set of resources, and perform a cell acquisition procedure based on the system information.

Some examples of the method, UEs, and non-transitory computer-readable medium described herein may further include operations, features, means, or instructions for monitoring a synchronization raster point, where monitoring the first subset of the set of resources and the second subset of the set of resources may be based on monitoring the synchronization raster point.

Some examples of the method, UEs, and non-transitory computer-readable medium described herein may further include operations, features, means, or instructions for monitoring a channel bandwidth with a channel raster of 100 kHz based on monitoring the synchronization raster point, where the channel raster may be associated with the SSB.

Some examples of the method, UEs, and non-transitory computer-readable medium described herein may further include operations, features, means, or instructions for receiving a primary synchronization signal (PSS) via a first set of multiple resource blocks of the first portion of resource blocks, receiving a secondary synchronization signal (SSS) via a second set of multiple resource blocks of the first portion of resource blocks, receiving the first part of the PBCH and one or more first demodulation reference signals (DMRSs) of a set of DMRSs via a third set of multiple resource blocks of the first portion of resource blocks, and receiving the second part of the PBCH and one or more second DMRSs of the set of DMRSs via a fourth set of multiple resource blocks of the second portion of resource blocks.

In some examples of the method, UEs, and non-transitory computer-readable medium described herein, the first set of multiple resource blocks, the second set of multiple resource blocks, and the third set of multiple resource blocks may be associated with a first set of frequency resources, and the fourth set of multiple resource blocks may be associated with a second set of frequency resources.

Some examples of the method, UEs, and non-transitory computer-readable medium described herein may further include operations, features, means, or instructions for demapping the first part of the PBCH and the one or more first DMRSs based on the third set of multiple resource blocks and the second part of the PBCH and the one or more second DMRSs based on the fourth set of multiple resource blocks, where the first part of the PBCH may be an initial part of the PBCH and the second part of the PBCH may be a subsequent part of the PBCH.

Some examples of the method, UEs, and non-transitory computer-readable medium described herein may further include operations, features, means, or instructions for demapping a first frequency-domain subcarrier for the first part of the PBCH and the one or more first DMRSs based on the third set of multiple resource blocks, where the first frequency-domain subcarrier may be counted relative to a first initial subcarrier of the third set of multiple resource blocks, demapping a first time-domain symbol, after demapping the first frequency-domain subcarrier, for the first part of the PBCH and the one or more first DMRSs based on the third set of multiple resource blocks, demapping a second frequency-domain subcarrier for the second part of the PBCH and the one or more second DMRSs based on the fourth set of multiple resource blocks, where the second frequency-domain subcarrier may be counted relative to a second initial subcarrier of the fourth set of multiple resource blocks, and demapping a second time-domain symbol, after demapping the second frequency-domain subcarrier, for the second part of the PBCH and the one or more second DMRSs based on the fourth set of multiple resource blocks.

In some examples of the method, UEs, and non-transitory computer-readable medium described herein, the first part of the PBCH and the second part of the PBCH may be encoded using a same encoding scheme.

In some examples of the method, UEs, and non-transitory computer-readable medium described herein, the first part of the PBCH may be encoded using a first redundancy version and the second part of the PBCH may be encoded using a second redundancy version different from the first redundancy version.

In some examples of the method, UEs, and non-transitory computer-readable medium described herein, the first portion of resource blocks may be associated with a first set of subcarriers, the second portion of resource blocks may be associated with a second set of subcarriers and the first set of subcarriers and the second set of subcarriers may be a same set of subcarriers.

In some examples of the method, UEs, and non-transitory computer-readable medium described herein, the first portion of resource blocks may be associated with a first set of subcarriers, and the second portion of resource blocks may be associated with a second set of subcarriers, and the first set of subcarriers and the second set of subcarriers may be different set of subcarriers.

In some examples of the method, UEs, and non-transitory computer-readable medium described herein, at least the first portion of resource blocks may be associated with a subcarrier spacing of 7.5 kHz.

In some examples of the method, UEs, and non-transitory computer-readable medium described herein, refrain from monitoring for a subset of the second set of subcarriers based on the subset of the second set of subcarriers being outside a channel bandwidth associated with the set of resources.

In some examples of the method, UEs, and non-transitory computer-readable medium described herein, to monitoring the second subset of the set of resources may include operations, features, means, or instructions for monitoring for the second portion of resource blocks with different mapping patterns based on a channel bandwidth associated with the set of resources, where the mapping patterns include at least a first mapping pattern mapping to frequency resource after an ending subcarrier of the first subset of the set of resources, a second mapping pattern mapping to second frequency resources before an initial subcarrier of the first subset of the set of resources, and a third mapping pattern mapping to third frequency resources after the ending subcarrier of the first subset of the set of resources and before the initial subcarrier of the first subset of the set of resources.

Some examples of the method, UEs, and non-transitory computer-readable medium described herein may further include operations, features, means, or instructions for receiving, via a broadcast system information message, an indication of a mapping pattern for the second portion of resource blocks, where the mapping pattern may be based on the channel bandwidth associated with the set of resources.

In some examples of the method, UEs, and non-transitory computer-readable medium described herein, the first portion of resource blocks may be associated with a first set of time resources, the second portion of resource blocks may be associated with a second set of time resources and the first set of time resources and the second set of time resources may be different.

In some examples of the method, UEs, and non-transitory computer-readable medium described herein, the first portion of resource blocks may be associated with a first set of subcarriers, and the second portion of resource blocks may be associated with a second set of subcarriers corresponding to frequencies greater than the first set of subcarriers.

In some examples of the method, UEs, and non-transitory computer-readable medium described herein, the first portion of resource blocks may be associated with a first set of subcarriers, and the second portion of resource blocks may be associated with a second set of subcarriers corresponding to frequencies less than the first set of subcarriers.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports synchronization signal block (SSB) design for machine type communication (MTC) and non-MTC UEs in accordance with one or more aspects of the present disclosure.

FIG. 2 shows an example of a wireless communications system that supports SSB design for MTC and non-MTC UEs in accordance with one or more aspects of the present disclosure.

FIG. 3 shows an example of a channel synchronization locations that supports SSB design for MTC and non-MTC UEs in accordance with one or more aspects of the present disclosure.

FIG. 4 shows an example of a SSB frequency domain pattern that supports SSB design for MTC and non-MTC UEs in accordance with one or more aspects of the present disclosure.

FIG. 5 shows an example of an SSB frequency domain pattern that supports SSB design for MTC and non-MTC UEs in accordance with one or more aspects of the present disclosure.

FIG. 6 shows an example of an SSB frequency domain pattern that supports SSB design for MTC and non-MTC UEs in accordance with one or more aspects of the present disclosure.

FIG. 7 shows an example of an SSB frequency domain pattern that supports SSB design for MTC and non-MTC UEs in accordance with one or more aspects of the present disclosure.

FIG. 8 shows an example of an SSB frequency domain pattern that supports SSB design for MTC and non-MTC UEs in accordance with one or more aspects of the present disclosure.

FIG. 9 shows an example of an SSB frequency domain pattern that supports SSB design for MTC and non-MTC UEs in accordance with one or more aspects of the present disclosure.

FIG. 10 shows an example of a process flow that supports SSB design for MTC and non-MTC UEs in accordance with one or more aspects of the present disclosure.

FIGS. 11 and 12 show block diagrams of devices that support SSB design for MTC and non-MTC UEs in accordance with one or more aspects of the present disclosure.

FIG. 13 shows a block diagram of a communications manager that supports SSB design for MTC and non-MTC UEs in accordance with one or more aspects of the present disclosure.

FIG. 14 shows a diagram of a system including a device that supports SSB design for MTC and non-MTC UEs in accordance with one or more aspects of the present disclosure.

FIGS. 15 through 17 show flowcharts illustrating methods that support SSB design for MTC and non-MTC UEs in accordance with one or more aspects of the present disclosure.

### DETAILED DESCRIPTION

In some wireless communications systems, a user equipment (UE) may receive a synchronization signal block (SSB) from a network entity. The UE may decode system information associated with the SSB to perform cell acquisition. The UE may monitor for the SSB in accordance with a capability of the UE. For example, the UE may be an example of a machine type communication (MTC) UE or a non-MTC UE. An MTC UE, which may be a UE supported in a low-power wide area network (LPWA UE) or an internet of things (IoT) device, such as a smart meter, or sensor. The MTC UE may have the capability to monitor for the SSB on a limited bandwidth (e.g., 3 megahertz (MHz)), while a non-MTC UE may have the capability to monitor for the SSB on a different (e.g., broader, higher) bandwidth (e.g., 5 MHz or larger). In some cases, the MTC UE may be unable to monitor all resources of the SSB based on the limited bandwidth. For example, the resources of the SSB may span a bandwidth larger than the limited bandwidth. The MTC UE may puncture portions of the SSB based on the limited bandwidth. In some examples, the MTC UE may puncture discontinuous portions of a physical broadcast channel (PBCH) increasing a coding rate of the PBCH and decreasing communications reliability.

According to techniques described herein, the network entity may transmit an SSB that supports the capabilities of both the MTC UE and the non-MTC UE. A mapping for a PBCH may include mapping an initial portion of the PBCH to a limited bandwidth of the MTC UE. For example, the MTC UE and the non-MTC UE may both receive and decode an initial portion of a PBCH. Receiving the initial portion of the PBCH may increase communications reliability between the MTC UE and the network entity. In some examples, an entire PBCH may be mapped to the limited bandwidth of the MTC UE. In some examples, a non-MTC UE may receive and decode a second part of the PBCH mapped to the second bandwidth of the non-MTC UE. The MTC UE may puncture a subset of the second part of the PBCH or otherwise decode the PBCH without the second part of the PBCH. In some examples, the network entity may refrain from transmitting a subset of the second part of the PBCH based on a channel bandwidth associated with the SSB.

Aspects of the disclosure are initially described in the context of wireless communications systems. Additional aspects of the disclosure are described in the context of channel synchronization locations, SSB designs, and process flows. Aspects of the disclosure are further illustrated by and described with reference to apparatus diagrams, system diagrams, and flowcharts that relate to SSB design for MTC and non-MTC UEs.

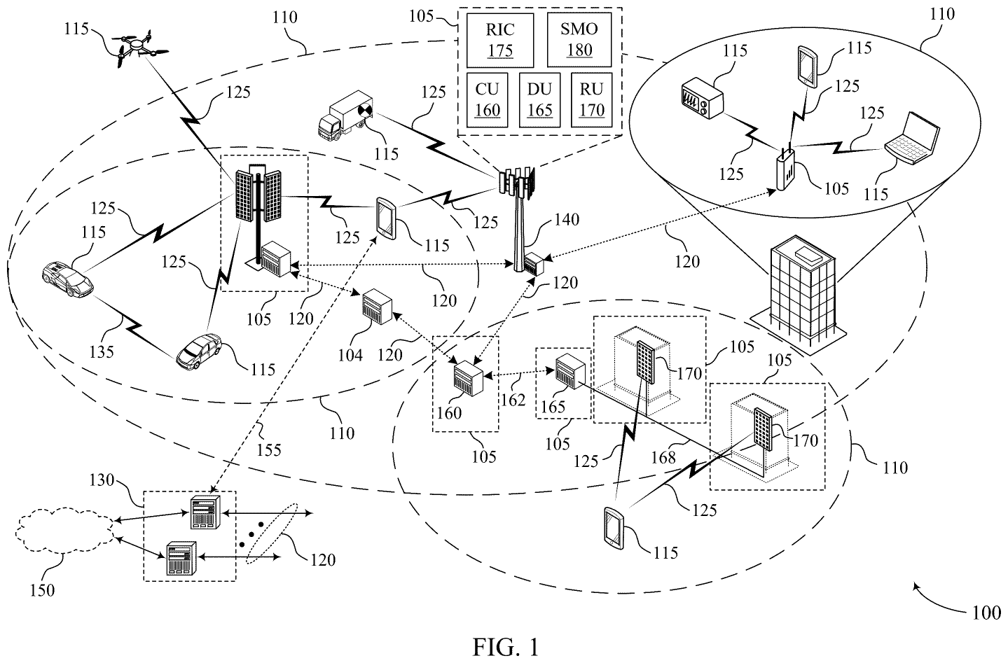

FIG. 1 shows an example of a wireless communications system 100 that supports SSB design for MTC and non-MTC UEs in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support SSB design for MTC and non-MTC UEs as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 MHz to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

According to techniques described herein, the network entity 105 may transmit an SSB that supports the capabilities of both the MTC UE 115 and the non-MTC UE 115. A mapping for a PBCH may map an initial portion of the PBCH to a limited bandwidth of the MTC UE 115. For example, the MTC UE 115 and the non-MTC UE 115 may both receive and decode an initial portion of a PBCH. Receiving the initial portion of the PBCH may increase communications reliability between the MTC UE 115 and the network entity 105. In some examples, an entire PBCH may be mapped to the limited bandwidth of the MTC UE 115. In some examples, a non-MTC UE 115 may receive and decode a second part of the PBCH mapped to the second bandwidth of the non-MTC UE 115. The MTC UE 115 may puncture the second part of the PBCH or otherwise decode the PBCH without the second part of the PBCH. In some examples, the network entity 105 may refrain from transmitting a subset of the second part of the PBCH based on a channel bandwidth associated with the SSB.

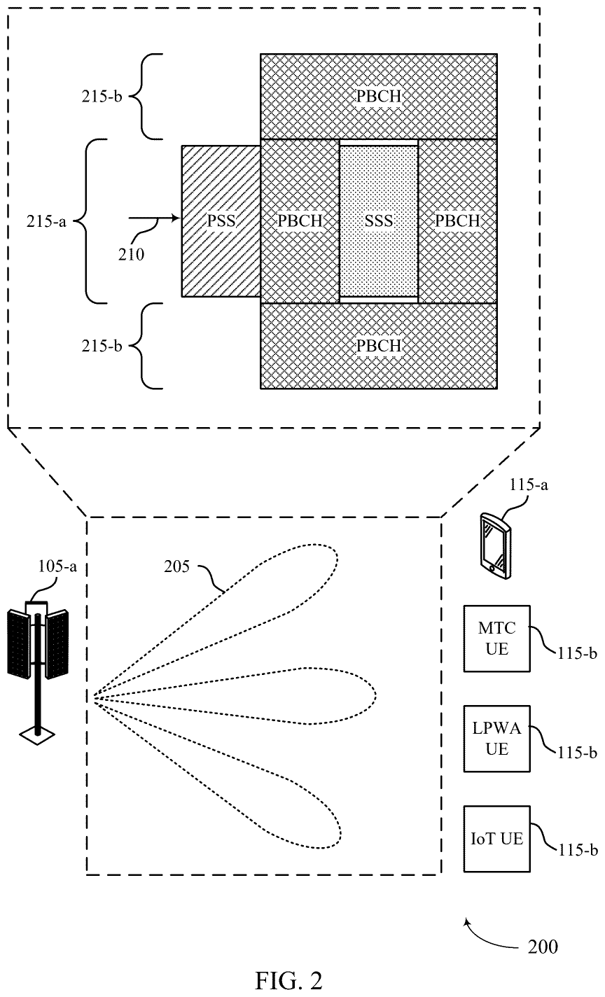

FIG. 2 shows an example of a wireless communications system 200 that supports SSB design for MTC and non-MTC UEs in accordance with one or more aspects of the present disclosure. In some examples, wireless communications system 200 may implement aspects of wireless communications system 100. For example, a UE 115-a and a UE 115-b may represent an example of a UE, such as the UEs 115 described with reference to FIG. 1. The UE 115-a may be an example of a non-MTC UE 115-a, and the UE 115-b may be an example of an MTC UE, a LPWA UE, or an IoT UE. A network entity 105-a and may represent an example of a network entity, such as the network entities 105 described with reference to FIG. 1. The non-MTC UE 115-a and the MTC UE 115-b may receive an SSB 205 via a corresponding beam. The UEs 115 may perform cell acquisition based on receiving the SSB 205.

In some wireless communications systems, different UEs 115 may be associated with different UE capabilities. For example, a UE 115-a may be a non-MTC UE 115-a, and a UE 115-b may be an MTC UE 115-b. The non-MTC UE 115-a may have the capability to monitor a first bandwidth, and the MTC UE 115-b may have the capability to monitor a second bandwidth less than (e.g., lower in frequency or narrower in frequency relative to) the first bandwidth. In some examples, the MTC UE 115-b may be an example of a NB-IoT wireless device. The NB-IoT wireless device may be associated with a downlink throughput (e.g., 32 kilobytes per second (kbps)) and an uplink throughput (e.g., 66 kbps). The NB-IoT wireless device may include a single receive antenna (e.g., 1Rx). For example, the NB-IoT wireless device may monitor a first bandwidth (e.g., 180 kilohertz (kHz) or a single physical resource block (PRB) of a radio frequency or baseband), and the NB-IoT device may transmit via a second bandwidth (e.g., 3.75 kHz or a single PRB). A coverage extension of the NB-IoT device may be a 164 decibel (dB) maximum coupling loss (MCL).

In some examples, the MTC UE 115-b may be an example of a category zero (CAT 0) MTC wireless device or a category M1 (CAT M1) enhanced MTC (eMTC) wireless device. The CAT 0 MTC wireless device or the CAT M1 eMTC wireless device may support a first throughput (e.g., 1 megabits per second (Mbps)) for full duplex operation and a second throughput (e.g., 300 kbps) for half duplex operations (e.g., Type-B half duplex operations). The CAT 0 MTC wireless device or the CAT M1 eMTC wireless device may include a single receive antenna (e.g., 1RX) and may monitor a first bandwidth (e.g., 1.08 MHz or six PRBs of a radio frequency or baseband). A coverage extension of the CAT 0 MTC wireless device may be a 140 dB MCL. A coverage extension of the CAT M1 eMTC wireless device may be a 154 dB MCL.

In some examples, the MTC UE 115-b may be an example of a category one (CAT1) wireless device. The CAT 1 wireless device may support a first throughput (e.g., 10 Mbps for downlink and a second throughput (e.g., 5 Mbps) for uplink during full duplex operations. In some examples, the CAT1 wireless device may include multiple receive antennas (e.g., 2RX). In some examples, the CAT 1 wireless device may be an example of a CAT1 bis wireless device, and the CAT1 bis wireless device may include a single receive antenna (e.g., 1RX). The CAT 1 wireless device may monitor a first bandwidth (e.g., 20 MHz of a radio frequency or baseband).

In some examples, the MTC UE 115-b may be an example of a Non reduced capability (RedCap) UE 115. The Non-RedCap UE 115 may monitor up to a first bandwidth (e.g., 100 MHz) for a first frequency range (FR1) and a second bandwidth (e.g., 400 MHz) for a second frequency range (FR2). In some examples, the MTC UE 115-b may be an example of a RedCap UE 115. The RedCap UE 115 may monitor up to a first bandwidth (e.g., 20 MHz) for a FR1 and a second bandwidth (e.g., 100 MHz) for FR2. In some examples, the MTC UE 115-b may be an example of an enhanced RedCap UE 115. In some examples, the eRedCap UE 115 may monitor a same bandwidth as a RedCap UE 115. In some examples, the eRedCap UE 115 may monitor up to a third bandwidth (e.g., 20 MHz) for a system information block (SIB) or paging while in a RRC idle or inactive mode. In some examples, the eRedCap UE 115 may monitor up to a fourth bandwidth (e.g., 5 MHz) for unicast data in an RRC connected mode.

In some examples, the MTC UE 115-b may monitor a reduced bandwidth (e.g., less than 5 MHz). For example, the MTC UE 115-b may monitor up to a 3 MHz bandwidth (e.g., 12 PRBs or 15 PRBs) or up to a 5 MHz bandwidth (e.g., 20 PRBs).

In some examples, the MTC UE 115-b may be an IoT device. The MTC UE 115-b may support a first bandwidth (e.g., 3 MHz) for a baseband bandwidth. The first bandwidth may support a first quantity of PRBs (e.g., 15 PRBs) at a first sub-carrier spacing (SCS) (e.g., 15 kHz). The MTC UE 115-b may support a second bandwidth (e.g., 3 MHz or 5 MHz) for a radio frequency bandwidth. The MTC UE 115-b may support one or more receive antennas (e.g., 1RX or 2RX), and the MTC UE 115-b may support coverage extension for both downlink and uplink control signaling and both downlink and uplink data signaling.

Wireless networks may use cell acquisition procedures to establish connections between a UE 115 and the network entity 105 (e.g., one or more cells). As part of the cell acquisition procedure, the UE 115 may monitor for transmissions from any network entities 105 operating within an area. For example, the UE 115 may monitor for SSB transmissions from surrounding network entities 105 in order to identify or otherwise determine which cells are possibly available for a cell connection procedure.

As a part of a cell acquisition procedure, the network entity 105-a may transmit synchronization signaling to the non-MTC UE 115-a and the MTC UE 115-b. The UEs 115 may perform a cell search where the UEs 115 monitor a specific frequency, bandwidth, or frequency band to detect a primary synchronization signal (PSS) and a secondary synchronization signal (SSS) to acquire or otherwise determine time frequency synchronization information from the network entity 105-a transmitting the PSS/SSS signals. The UEs 115 may also identify or otherwise determine an identifier of the cell (e.g., such as a physical cell identifier (PCI)) from the PSS/SSS signals as well as other information to decode a PBCH from the network entity 105. Based on receiving the SSB transmissions from each surrounding cell, the UE 115 may have information used (e.g., such as time, frequency, and spatial resources) to decode a downlink signaling from the network entity 105.

For example, the network entity 105-a may transmit an SSB 205 to the non-MTC UE 115-a and the MTC UE 115-b. The SSB 205 may be associated with a synchronization raster point 210. The synchronization raster point 210 may indicate frequency positions of the SSB 205 for the non-MTC UE 115-a, the MTC UE 115 b, or both, to use for cell acquisition. For example, the synchronization raster point 210 may indicate a center frequency of the SSB 205 or a center frequency of a PSS or SSS of the SSB 205. The SSB 205 and the synchronization raster point 210 may be similar or the same for the non-MTC UE 115-a and the MTC UE 115-b.

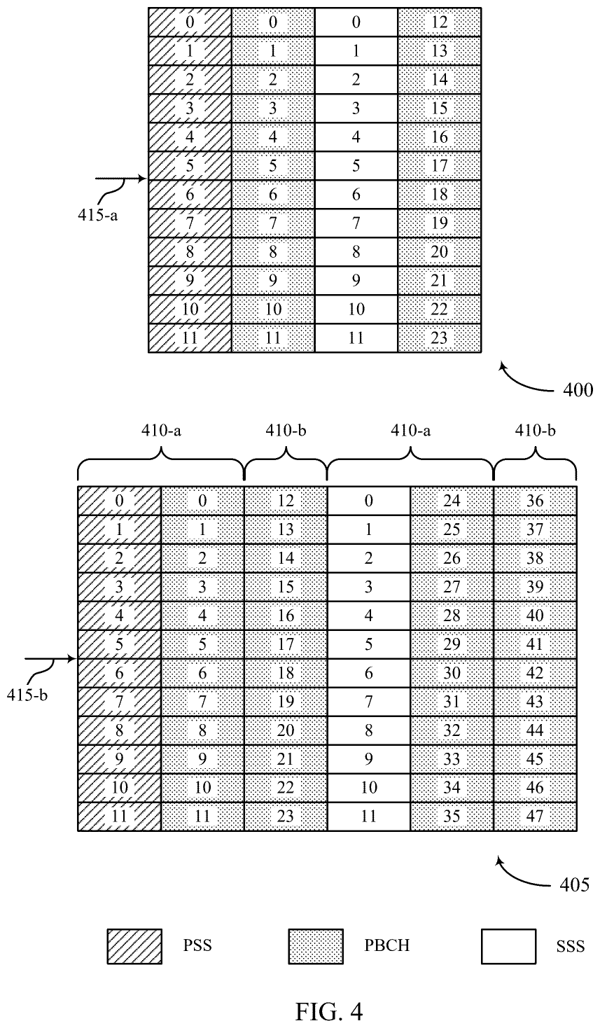

The network entity 105-a may transmit the SSB 205 in accordance with a SSB frequency domain pattern (e.g., as described with reference to FIG. 4-9). The PSS and the SSS of the SSB 205 may be centered on (e.g., sit on) the synchronization raster point 210. The SSB 205 may span an effective bandwidth of 12 PRBs. In some examples, the PBCH of the SSB 205 may share a center frequency with the PSS or the SSS (e.g., as illustrated in FIG. 2). In some examples, the PBCH of the SSB 205 may be offset by 4 PRBs, based on a location of a downlink channel bandwidth and the SSB 205 (e.g., the synchronization raster point 210).

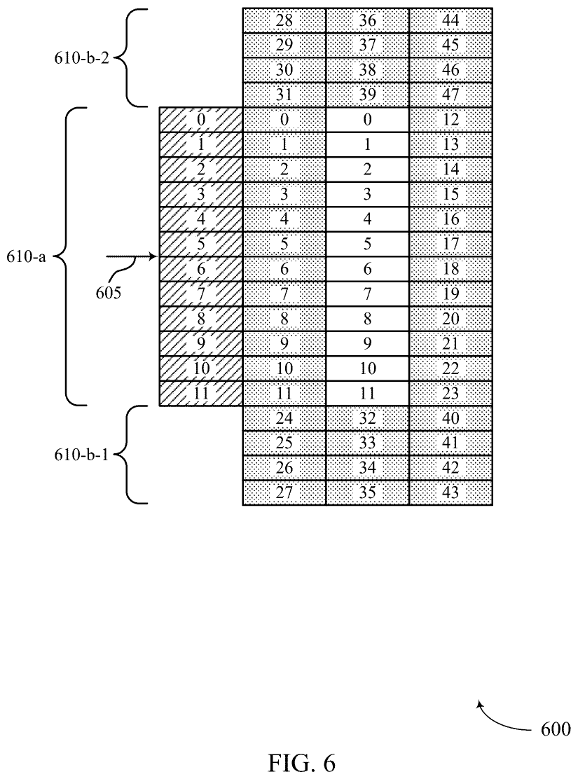

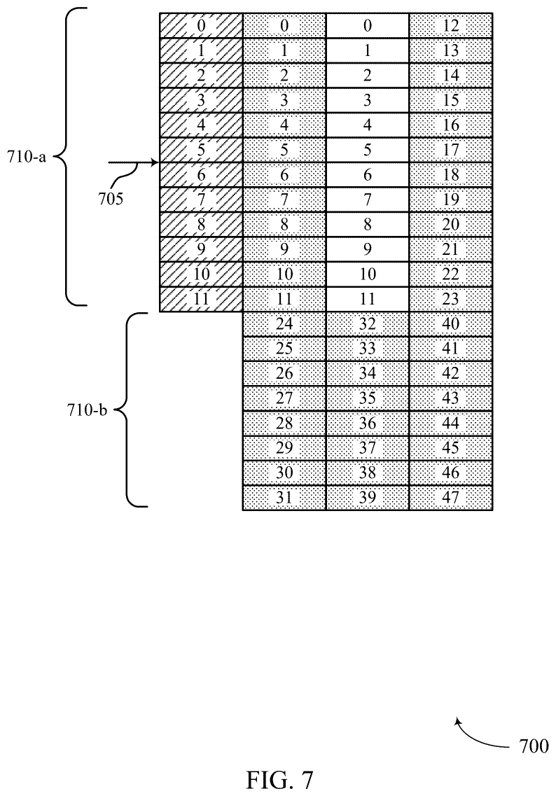

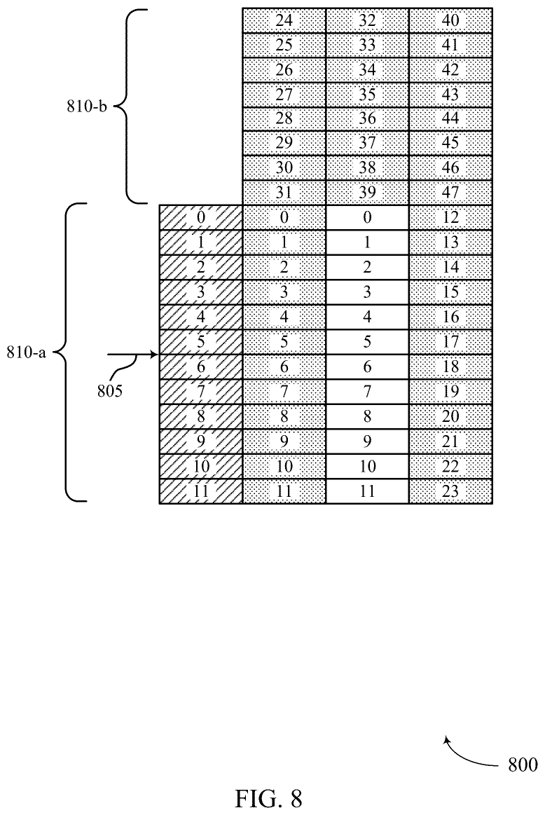

For example, a first portion of PRBs 215-a may be centered on the synchronization raster point 210. The first portion of PRBs 215-a may include the PSS, the SSS, and a first part of the PBCH. In some examples, the second portion of PRBs may be centered on the synchronization raster point 210 (e.g., as further described in FIG. 6). In some examples, the second portion of PRBs may be transmitted via sub-carriers of a lower frequency than the first portion of PRBs (e.g., as further described in FIG. 7). The second portion of PRBs may be offset by a negative quantity of PRBs (e.g., −4 PRBs). In some examples, the second portion of PRBs may be transmitted via sub-carries of a higher frequency than the first portion of PRBs (e.g., as further described in FIG. 8). The second portion of PRBs may be offset by a positive quantity of PRBs (e.g., 4 PRBs).

In some examples, the network entity 105-a may transmit an indication of the offset. For example, the network entity 105-a may be explicitly signaled (e.g., using 2 more bits) the offset as part of SSS. In some examples, the UEs 115 may blind decode the three possible SSB frequency domain patterns (e.g., hypotheses).

The MTC UE 115-b may be unable to monitor an entire bandwidth of the SSB 205 based on a first UE capability (e.g., a UE capability limiting a bandwidth able to be monitored by the MTC UE 115-b). The MTC UE 115-b may puncture the second portion of PRBs 215-b, and the MTC UE 115-b may monitor the first portion of PRBs 215-a. The non-MTC UE 115-a may monitor the entire bandwidth of the SSB 205 based on a second UE capability (e.g., a UE capability enabling the non-MTC UE 115-a to monitor the entire bandwidth of the SSB 205).

In some examples, the network entity 105-a may perform PBCH resource element mapping based on a frequency first and time second mapping scheme. For example, the network entity 105-a may map an initial portion of the PSS to a first (e.g., highest frequency) subcarrier at a first (e.g., initial) time, and the network entity 105-a may map a subsequent portion of the PSS to a second (e.g., second highest frequency) subcarrier at the first time. Additionally, or alternatively, the network entity 105-a may map PRBs of a PBCH such that an initial portion the PBCH is mapped to the second portion of PRBs 215-b.

The non-MTC UE 115-a and MTC UE 115-b may demap the PBCH based on a same PBCH resource element mapping. For example, puncturing the PBCH (e.g., 3 MHz puncturing) may not change the PBCH resource element mapping. The non-MTC UE 115-a and the MTC UE 115-b may receive a same part of the PBCH via the first portion of PRBs 215-a. The non-MTC UE 115-a may receive a second part of the PBCH via the second portion of PRBs 215-b. The MTC UE 115-b may not monitor the second portion of PRBs 215-b, and the MTC UE 115-b may puncture the second part of the PBCH.

For PBCH coding, the PBCH may include a quantity of PRBs (e.g., 48 PRBs) carrying a first quantity of data bits (e.g., 32 bits) and a second quantity of CRC bits (e.g., 24 bit CRC) with a first coding rate (e.g., coding rate=56/(48×9×2)˜= 1/16). The non-MTC UE 115-a may receive the PBCH at the first coding rate. The MTC UE 115-b may puncture the second portion of PRBs 215-b. After the puncturing, the equivalent coding rate may be a second coding rate (e.g., ˜=⅛). For example, the non-MTC UE 115-a may receive the PBCH at the second coding rate that is greater than the first coding rate.

To achieve, the non-MTC UE 115-a may receive the first part of the PBCH and the second part of the PBCH (e.g., PBCH of 20 PRBs) with a block error rate (BLER) of 1% under first channel conditions (e.g., signal interference and noise ratio (SINR)=−4.9 dB (+0%)). The MTC UE 115-b may receive the first part of the PBCH (e.g., 12 PRBs based on puncturing the second part of the PBCH) with a BLER of 1% under second channel conditions (e.g., SINR=−0.7 dB (+4.2 dB)). In some examples, the MTC UE 115-b may receive the first part of the PBCH (e.g., 12 PRBs based on puncturing the second part of the PBCH and power boosting (+2.2 dB) the first part of the PBCH) under third channel conditions (e.g., SINR=−2.7 dB (+2.2 dB)). In some examples, the non-MTC UE 115-a or the MTC UE 115-b may include a first antenna configuration (e.g., 4×2 antenna), a tapped delay line (e.g., 300 nanoseconds (ns)), and a minimum mean-squared error (MMSE)-channel estimation (ChEsti).

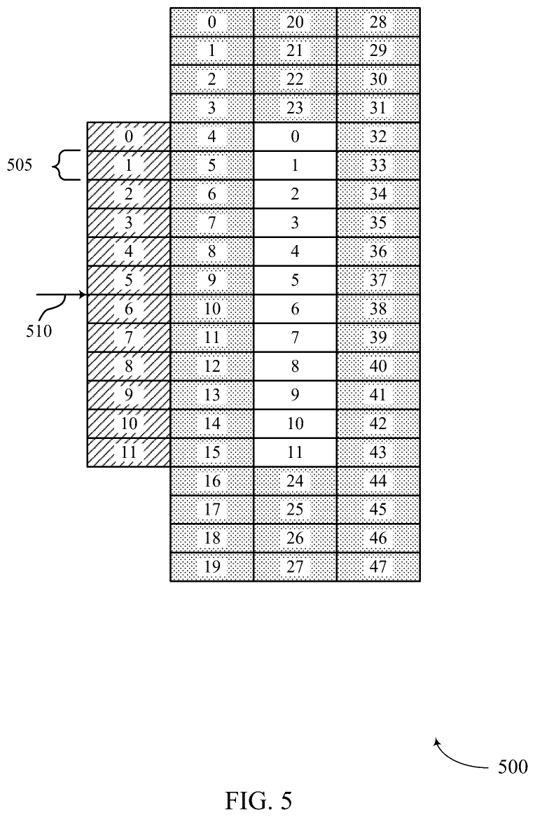

According to techniques described herein, the network entity 105 may transmit an SSB 205 that supports both the MTC UE 115-b and the non-MTC UE 115-a. A mapping for a PBCH may map an initial portion of the PBCH to a limited bandwidth of the MTC UE 115-b. For example, the MTC UE 115-b and the non-MTC UE 115-a may both receive and decode an initial portion of a PBCH (e.g., as described with reference to FIGS. 6-8). Receiving the initial portion of the PBCH may increase communications reliability between the MTC UE 115-b and the network entity 105-a. In some examples, an entire PBCH may be mapped to the limited bandwidth of the MTC UE 115-b (e.g., as described with reference to FIGS. 4 and 5). In some examples, a non-MTC UE 115-a may receive and decode a second part of the PBCH mapped to the second bandwidth of the non-MTC UE 115 115-a. The MTC UE 115 may puncture the second part of the PBCH or otherwise decode the PBCH without the second part of the PBCH. In some examples, the network entity 105-a may refrain from transmitting a subset of the second part of the PBCH based on a channel bandwidth associated with the SSB 205.

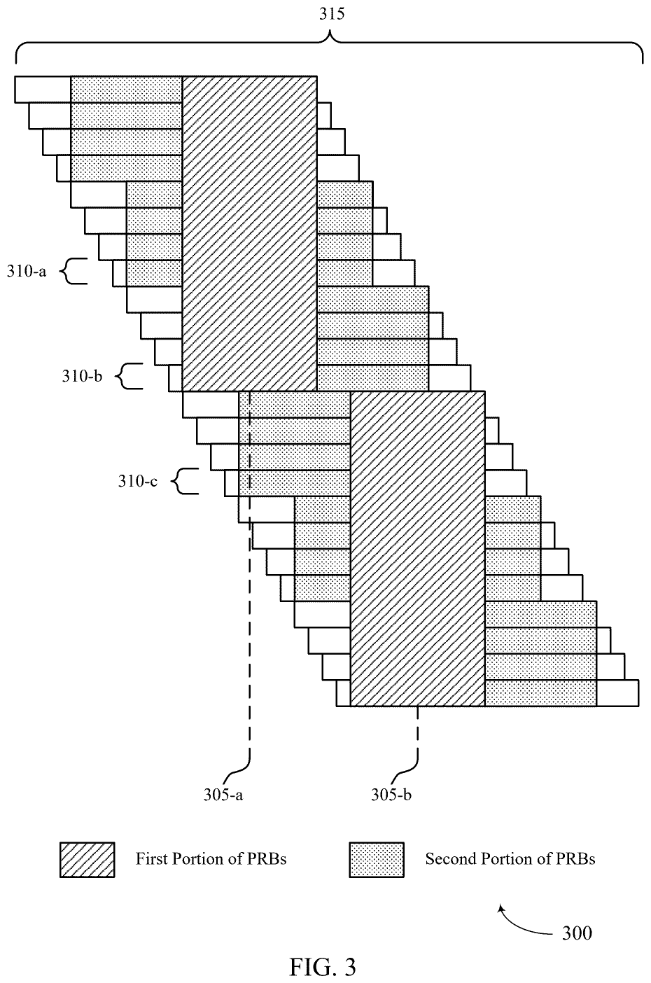

FIG. 3 shows an example of a channel synchronization locations 300 that supports SSB design for MTC and non-MTC UEs in accordance with one or more aspects of the present disclosure. The channel synchronization locations 300 may be implemented by communications between a UE 115 and a network entity 105, which may be examples of corresponding devices as described herein, including with reference to FIGS. 1 and 2. The network entity 105 may transmit an SSB in accordance with the channel synchronization locations 300. For example, the network entity 105 may transmit an SSB such that a PSS or a SSS are centered on a synchronization raster point 305 (e.g., a first synchronization raster point 305-a or a second synchronization raster point 305-b). For example, a first portion of PRBs (e.g., the first portion of PRBs 215-a as described with reference to FIG. 2) may be centered on a synchronization raster point 305. A second portion of PRBs (e.g., the second portion of PRBs 215-b as described with reference to FIG. 2) may be centered on the synchronization raster point 305 or offset from the synchronization raster point 305. The first portion of PRBs may include a PSS, an SSS, and a first part of a PBCH. The second portion of PRBs may include a second part of a PBCH.

The network entity 105 may transmit the SSB via multiple downlink channels 310 based on a global synchronization channel location (GSCN). Each downlink channel 310 may be offset by a PRB. The UE 115 may scan a downlink channel bandwidth 315 using the synchronization raster points 305. To reduce the quantity of synchronization raster points 305 used to cover the multiple downlink channels 310, a network entity 105 may transmit SSBs in accordance with multiple SSB patterns via the multiple downlink channels 310. For example, using a single SSB pattern, the UE 115 may scan the multiple downlink channels 310 using six synchronization raster points 305. Using multiple SSB patterns, the UE 115 may scan the multiple downlink channels 310 using two synchronization raster points 305 (e.g., as illustrated in FIG. 3). For example, the UE 115 may use the first synchronization raster point 305-a and the second synchronization raster point 305-b to cover all the possible downlink channels 310.

For example, on a first downlink channel 310-a, the network entity 105 may transmit an SSB in accordance with a first SSB pattern. In the first SSB pattern, the second portion of PRBs may be centered on the first synchronization raster point 305-a (e.g., as further described with reference to FIG. 6). On a second downlink channel 310-b, the network entity 105 may transmit an SSB in accordance with a second SSB pattern. In the second SSB pattern, the second portion of PRBs may be offset a negative quantity of PRBs (e.g., as further described with reference to FIG. 7). On a third downlink channel 310-c the network entity 105 may transmit an SSB in accordance with a third SSB pattern. In the third SSB pattern, the third portion of PRBs may be offset a positive quantity of PRBs (e.g., as further described with reference to FIG. 8).

In some cases, the UE 115 may monitor synchronization raster points 305 separated by 100 kHz or more (e.g., every 100 kHz within a channel bandwidth). If the UE 115 (e.g., a non-MTC UE 115-a as described with reference to FIG. 2) includes a UE capability to monitor a first bandwidth (e.g., ≥5 MHz), a synchronization raster point 305 may be defined, e.g., by Equation 1 for an FR1.

$$N * 1200 kHz + M * 50 kHz , N ϵ \{ 1 : 2499 \} , M ϵ \{ 1 , 3 , 5 \} \qquad ( 1 )$$

Additionally, or alternatively, a synchronization raster point 305 may be defined, e.g., by Equation 2 for an FR2.

$$N * 1.44 MHz + 3000 MHz , N ϵ \{ 1 : 14756 \} \qquad ( 2 )$$

If the UE 115 (e.g., a MTC UE 115-b as described with reference to FIG. 2) includes a UE capability to monitor a second bandwidth (e.g., 3 MHz) less than the first bandwidth, a synchronization raster point 305 may be separate from that of the UE 115 capable to monitor a first bandwidth (e.g., a non-MTC UE 115-a). For example, the synchronization raster point 305 for the MTC UE 115-b may be defined, e.g., by Equation 1 for an FR1.

$$N * 600 kHz + M * 50 kHz + 300 kHz , N ϵ \{ 1 : 1665 \} , M ϵ \{ 1 , 3 , 5 \} \qquad ( 3 )$$

In some cases, if the UE 115 (e.g., a non-MTC UE 115-a as described with reference to FIG. 2) includes a UE capability to monitor a first bandwidth (e.g., a minimum bandwidth of 5 MHz including a maximum quantity of 25 PRBs), a synchronization raster point 305 may be defined, e.g., by Equation 4.

$$N * 1200 kHz + M * 50 kHz + X , N ϵ \{ 1 : 2499 \} , M ϵ \{ 1 , 3 , 5 \} \qquad ( 4 )$$

As described in Equation 4, X may be a constant value. If the UE 115 (e.g., a MTC UE 115-b as described with reference to FIG. 2) includes a UE capability to monitor an SSB bandwidth of a quantity of PRBs (e.g., a maximum quantity of PRBs) for the second bandwidth (e.g., 3 MHz including an SSB of a maximum quantity of 15 PRBs) less than the first bandwidth, a synchronization raster point 305 may be separate by 100 kHz or more (e.g., every 100 kHz in a channel bandwidth). If the UE 115 includes a UE capability to monitor a SSB bandwidth less than the quantity of PRBs for the second bandwidth (e.g., a 3 MHz bandwidth including an SSB of 12 PRBs), a synchronization raster point 305 may be defined, e.g., by Equation 5.

$$N * 600 kHz + M * 50 kHz + y , N ϵ \{ 1 : 1665 \} , M ϵ \{ 1 , 3 , 5 \} \qquad ( 5 )$$

As described in Equation 5, Y may be a constant value. For example, different synchronization raster points 305 may be used to separately support the different types of UEs 115 (e.g., the non-MTC UE 115-a and the MTC UE 115-b). The UEs 115 with different capabilities may monitor for corresponding synchronization raster points 305. Additionally, or alternatively, the synchronization raster points 305 defined by Equation 4 and Equation 5 may support the different types of UEs 115. The synchronization raster points 305 defined by Equation 4 and Equation 5 may provide the network entity 105-a with more flexibility to select a channel bandwidth per synchronization raster point 305. The UEs 115 with different capabilities may monitor the synchronization raster points defined by Equation 4 and 5 (e.g., all the possible synchronization raster points 305).

FIG. 4 shows an example of an SSB frequency domain pattern 400 that supports SSB design for MTC and non-MTC UEs in accordance with one or more aspects of the present disclosure. The SSB frequency domain pattern 400 may be implemented by communications between a UE 115 and a network entity 105, which may be examples of corresponding devices as described herein, including with reference to FIGS. 1 and 3. The network entity 105 may transmit an SSB in accordance with the SSB frequency domain pattern 400. For example, the network entity 105 may map the SSB to PRBs in accordance with the SSB frequency domain pattern 400. The network entity 105 may transmit the SSB at the synchronization raster point 415 (e.g., a synchronization raster point 415-a or a synchronization raster point 415-b) as described with reference to FIG. 3.

As illustrated in SSB frequency domain pattern 400, the network entity 105 may map PBCH within a same bandwidth (e.g., 12 PRBs) as a PSS and SSS. For example, a first portion of PRBs (e.g., a first portion of PRBs 215-a as described with reference to FIG. 2) and a second portion of PRBs (e.g., a second portion of PRBs 215-b as described with reference to FIG. 2) may be included with the same bandwidth. A first UE 115 including a first capability (e.g., the non-MTC UE 115-a as described with reference to FIG. 2) and a second UE 115 include a second capability (e.g., the MTC UE 115-b as described with reference to FIG. 2) may both monitor an entire bandwidth (e.g., 12 PRBs) of the SSB.

The network entity 105 may perform PBCH and demodulation reference signal (DMRS) resource element mapping based on a frequency first and time second mapping scheme within the bandwidth (e.g., 12 PRBs), as described with reference to FIG. 2. For example, the network entity 105 may map an initial portion of the PBCH (e.g., PRB 0 as illustrated in FIG. 4) to a first (e.g., highest frequency) subcarrier at a first time, and the network entity 105-a may map a subsequent portion of the PBCH (e.g., PRB 1 as illustrated in FIG. 4) to a second (e.g., second highest frequency) subcarrier at the first time. The mapping may continue until a subsequent portion of the PBCH (e.g., PRB 11 as illustrated in FIG. 4) is mapped to a final (e.g., lowest frequency) subcarrier at the first time. The network entity 105 may map a subsequent portion of the PBCH (e.g., PRB 12 as illustrated in FIG. 4) to the first subcarrier at a second time. The PBCH coding rate may be the same as the punctured PBCH coding rate for the SSB 205 described with reference to FIG. 2. For example, the PBCH may include a quantity of PRBs (e.g., 24 PRBs) carrying a first quantity of data bits (e.g., 32 bits) and a second quantity of CRC bits (e.g., 24 bit CRC) with a first coding rate (e.g., coding rate=56/(24×9×2)˜=⅛).

As illustrated in SSB frequency domain pattern 405, to improve a performance associated with the PBCH, the network entity 105 may introduce additional PBCH symbols. For example, the network entity 105 may transmit the PBCH via a first portion of PRBs 410-a and a second portion of PRBs 410-b. The additional PBCH symbols (e.g., PBCH symbols associated with the second portion of PRBs 410-b) may decrease a coding rate associated with the PBCH, increasing communications reliability of PBCH detection.

In some examples, to improve a performance associated with the PBCH, the network entity 105 may reduce master information block (MIB) bits or CRC bits to increase the coding gain. In some examples, the network entity 105 may utilize multi-shot PBCH. For example, the network entity 105 may transmit an SSB multiple times in succession and in such cases, the multiple instances of the transmitted SSB may be combined at a UE 115.

FIG. 5 shows an example of an SSB frequency domain pattern 500 that supports SSB design for MTC and non-MTC UEs in accordance with one or more aspects of the present disclosure. The SSB frequency domain pattern 500 may be implemented by communications between a UE 115 and a network entity 105, which may be examples of corresponding devices as described herein, including with reference to FIGS. 1 and 4. The network entity 105 may transmit an SSB in accordance with the SSB frequency domain pattern 500. For example, the network entity 105 may map the SSB to PRBs in accordance with the SSB frequency domain pattern 500. The network entity 105 may transmit the SSB at the synchronization raster point 510 as described with reference to FIG. 3.

As illustrated in SSB frequency domain pattern 500, the network entity 105 may map an SSB associated with a first bandwidth (e.g., 20 PRB) based on utilizing smaller SCS 505 and longer symbol durations. For FR1, an SSB may include a reduced SCS 505 (e.g., SCS=7.5 kHz or 15 kHz instead of SCS=15 kHz or 30 kHz). For example, a first SSB may be associated with a SCS 505 of 7.5 kHz including the same total throughput as a second SSB associated with a SCS 505 of 15 kHz (e.g., equivalent to SCS=15 kHz). For example, the first SSB may include two symbols for PSS, 2 two symbols for SSS, and six symbols for PBCH. The first SSB may be associated with a first bandwidth (e.g., 1.8 MHz) with 20 PRBs at a SCS of 7.5 kHz, and the second SSB may be associated with a second bandwidth (e.g., 3.6 MHz) with 20 PRBs at a SCS of 15 kHz. For FR2, an SSB may include a reduced SCS 505 (e.g., SCS=30 kHz or 60 kHz instead of SCS=60 kHz or 120 kHz).

FIG. 6 shows an example of an SSB frequency domain pattern 600 that supports SSB design for MTC and non-MTC UEs in accordance with one or more aspects of the present disclosure. The SSB frequency domain pattern 600 may be implemented by communications between a UE 115 and a network entity 105, which may be examples of corresponding devices as described herein, including with reference to FIGS. 1 and 5. The network entity 105 may transmit an SSB in accordance with the SSB frequency domain pattern 600. For example, the network entity 105 may map the SSB to PRBs in accordance with the SSB frequency domain pattern 600. The network entity 105 may transmit the SSB at the synchronization raster point 605, as described with reference to FIG. 3.

The network entity 105 apply a PBCH or DMRS resource element mapping separately for a first portion of PRBs 610-a (e.g., the first portion of PRBs 215-a as described with reference to FIG. 2) and the second portion of PRBs 610-b (e.g., the second portion of PRBs 215-b as described with reference to FIG. 2). For example, the network entity 105 may map the first portion of PRBs 610-a in accordance with a first PBCH or DMRS resource element mapping scheme, and the network entity 105 may map the second portion of PRBs 610-b in accordance with a second PBCH or DMRS resource element mapping scheme. The first portion of PRBs 610-a may include the PSS, the SSS, and the first part of the PBCH (e.g., same 12 PRBs as PSS or SSS). The second portion of PRBs 610-b may include the second part of the PBCH (e.g., 12 PRBs out of the bandwidth associated with the PSS or SSS). The network entity 105 may perform PBCH and DMRS resource element mapping for the first portion of the PRBs 610-a based on a frequency first and time second mapping scheme, as described with reference to FIG. 4.

In some examples, PBCH coding for the first part of the PBCH may be repeated the second part of the PBCH. An MTC UE 115 may detects the first part of the PBCH. The first part of the PBCH may include an initial portion of the PBCH including a set of most non-redundant coded bits increasing communications reliability (e.g., ˜1 dB gain compared to the 12 PRB SSB with the PBCH outside the bandwidth of the PSS or the SSS, where the 12 PRB SSB may be punctured based on the PBCH or DMRS resource element mapping pattern (the SSB frequency domain pattern 500) as described with reference to FIG. 5). A non-MTC UE 115 may detect both the first part of the PBCH and the second part of the PBCH, which may improve communications reliability for (e.g., may be approximately 3 dB better than) the detection of the first part of the PBCH alone.

In some examples, the first part of the PBCH may be encoded using a first redundancy version (RV) and the second part of the PBCH is encoded using a second RV different from the first RV.

As illustrated in SSB frequency domain pattern 600, the second portion of PRBs may be centered on the synchronization raster point 605. In some examples, an initial subset of the second part of the PBCH may be mapped to a first subset of the second portion of the PRB 610-b-1. A subsequent subset of the second part of the PBCH may be mapped to a second subset of the second portion of the PRB 610-b-2.

FIG. 7 shows an example of an SSB frequency domain pattern 700 that supports SSB design for MTC and non-MTC UEs in accordance with one or more aspects of the present disclosure. The SSB frequency domain pattern 700 may be implemented by communications between a UE 115 and a network entity 105, which may be examples of corresponding devices as described herein, including with reference to FIGS. 1 and 6. The network entity 105 may transmit an SSB in accordance with the SSB frequency domain pattern 700. For example, the network entity 105 may map the SSB to PRBs in accordance with the SSB frequency domain pattern 700. The network entity 105 may transmit the SSB at the synchronization raster point 705, as described with reference to FIG. 3.

The network entity 105 apply a PBCH or DMRS resource element mapping separately for a first portion of PRBs 710-a (e.g., the first portion of PRBs 215-a as described with reference to FIG. 2) and the second portion of PRBs 710-b (e.g., the second portion of PRBs 215-b as described with reference to FIG. 2), as described with reference to FIG. 6. As illustrated in SSB frequency domain pattern 700, the second portion of PRBs 710-b may be offset by a negative quantity of PRBs (e.g., −4 PRBs). For example, the second portion of PRBs 710-b may be transmitted via sub-carriers of a lower frequency than the first portion of PRBs 710-a

FIG. 8 shows an example of an SSB frequency domain pattern 800 that supports SSB design for MTC and non-MTC UEs in accordance with one or more aspects of the present disclosure. The SSB frequency domain pattern 800 may be implemented by communications between a UE 115 and a network entity 105, which may be examples of corresponding devices as described herein, including with reference to FIGS. 1 and 7. The network entity 105 may transmit an SSB in accordance with the SSB frequency domain pattern 800. For example, the network entity 105 may map the SSB to PRBs in accordance with the SSB frequency domain pattern 800. The network entity 105 may transmit the SSB at the synchronization raster point 805, as described with reference to FIG. 3.

The network entity 105 apply a PBCH or DMRS resource element mapping separately for a first portion of PRBs 810-a (e.g., the first portion of PRBs 215-a as described with reference to FIG. 2) and the second portion of PRBs 810-b (e.g., the second portion of PRBs 215-b as described with reference to FIG. 2), as described with reference to FIG. 6. As illustrated in SSB frequency domain pattern 800, the second portion of PRBs may be offset by a positive quantity of PRBs (e.g., 4 PRBs). For example, the second portion of PRBs may be transmitted via sub-carries of a higher frequency than the first portion of PRBs

In some examples, the network entity 105 may indicate the SSB frequency domain pattern index to differentiate the SSB frequency domain pattern 600, 700, or 800 in the broadcast system information to avoid UE misdetection of SSB frequency domain patterns. A core resource set 0 (CORESET0) offset relative to the SSB may be defined as the RB offset between a lowest RB of CORESET0 and a lowest RB of a common first part of the SSB frequency domain pattern 600, 700 or 800 (e.g., the lowest RB of the PSS or the SSS).

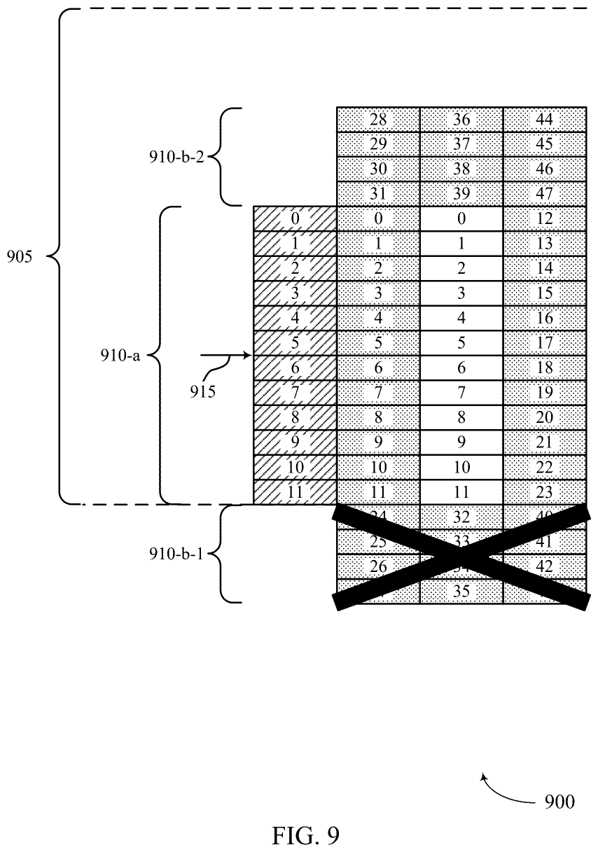

FIG. 9 shows an example of an SSB frequency domain pattern 900 that supports SSB design for MTC and non-MTC UEs in accordance with one or more aspects of the present disclosure. The SSB frequency domain pattern 900 may be implemented by communications between a UE 115 and a network entity 105, which may be examples of corresponding devices as described herein, including with reference to FIGS. 1 and 8. The network entity 105 may transmit an SSB in accordance with the SSB frequency domain pattern 900. For example, the network entity 105 may map the SSB to PRBs in accordance with the SSB frequency domain pattern 900. The network entity 105 may transmit the SSB at the synchronization raster point 915, as described with reference to FIG. 3.

An SSB may include a first part of a PBCH included in a first portion of PRBs 910-a and a second part of a PBCH included in a second portion of PRBs 910-b, as described in FIG. 6. The SSB may include a fixed PBCH frequency pattern (e.g., SSB frequency domain pattern 900). The fixed PBCH pattern may be symmetric around the center of PSS or SSS, as described in FIG. 6. The network entity 105 may transmit the SSB at the reduced quantity of synchronization raster points, as described with reference to FIG. 3. If any part of the PBCH is mapped to a subcarrier or PRB outside a channel bandwidth 905, the network entity 105 may not transmit the PRBs outside the channel bandwidth 905. The network entity 105 may relocate power to the remaining PRBs. For example, the network entity 105 may transmit an SSB at a synchronization raster point 915. A first subset of the second portion of PRBs 910-b-1 may be outside of the channel bandwidth 905. The network entity 105 may not transmit the first subset of the second portion of PRBs 910-b-1 based on the first subset of the second portion of PRBs 910-b-1 being outside the channel bandwidth 905.

The PBCH decoding may not be degraded significantly based on the power boosted first portion of PRBs 910-a, which may be inside the channel bandwidth 905. The fixed PBCH pattern may reduce UE complexity in PBCH frequency domain pattern detection. The UE may perform blind detection of the first portion of the PBCH and the punctured second portion of the PBCH within the channel bandwidth 905.

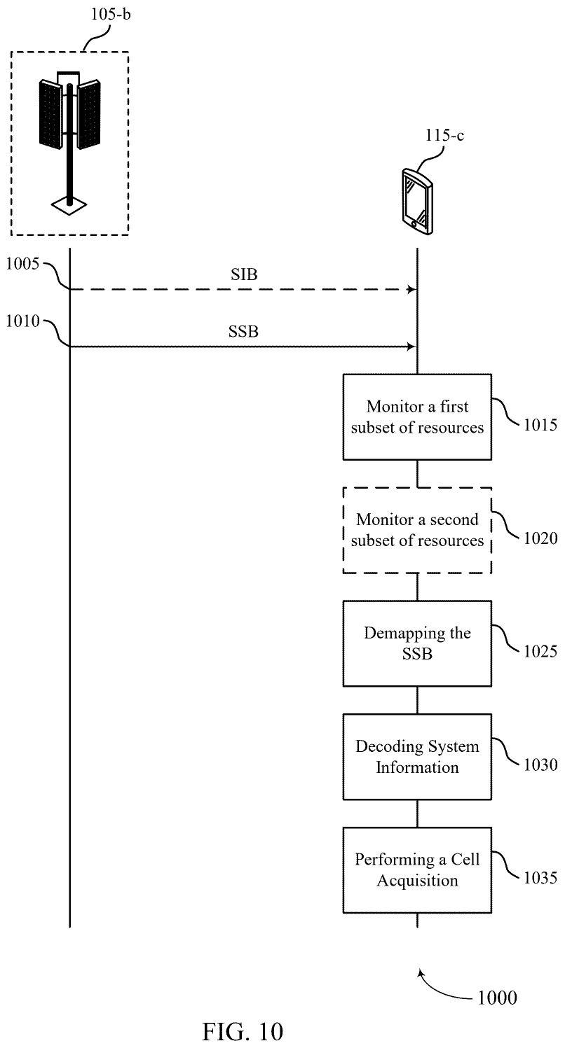

FIG. 10 shows an example of a process flow 1000 that supports SSB design for MTC and non-MTC UEs in accordance with one or more aspects of the present disclosure. In some examples, process flow 1000 may implement aspects of, or be implemented by aspects of, the wireless communications system 100, the wireless communications system 200, the channel synchronization locations 300, the SSB frequency domain pattern 400, the SSB frequency domain pattern 405, SSB frequency domain pattern 500, SSB frequency domain pattern 600, SSB frequency domain pattern 700, SSB frequency domain pattern 800, or SSB frequency domain pattern 900. For example, the process flow 1000 may include a UE 115-c and a network entity 105-b which may be examples of corresponding devices described with reference to FIGS. 1-9. The UE 115-c may be an example of the non-MTC UE 115-a or the MTC UE 115-b, as described with reference to FIG. 2.

At 1005, the UE 115-c may receive, via a broadcast system information message, an indication of a mapping pattern for a second portion of resource blocks. The mapping pattern may be based on the channel bandwidth associated with the set of resources.

At 1010, the network entity 105 may transmit an SSB in accordance with an SSB frequency domain pattern, as described with reference to FIGS. 4-9. The UE 115-c may receive a PSS via a first set of resource blocks of the first portion of resource blocks.

In some cases, the first set of resource blocks, the second set of resource blocks, and the third set of resource blocks may be associated with a first set of frequency resources, and the fourth set of resource blocks may be associated with a second set of frequency resources, as described with reference to FIGS. 6-9. In some cases, the first part of the PBCH and the second part of the PBCH may be encoded using a same encoding scheme. In some cases, the first part of the PBCH may be encoded using a first RV and the second part of the PBCH may be encoded using a second RV different from the first RV.

At 1015, the UE 115-c may monitor a first subset of a set of resources for a first portion of resource blocks (e.g., the first portion of PRBs 215-a as described with reference to FIG. 2) of a SSB based on a capability of the UE (e.g., a UE capability associated with the non-MTC UE 115-a). For example, the non-MTC UE 115-a and the MTC UE 115-b may monitor the first subset of the set of resources. The UE 115-c may receive a SSS via a second set of resource blocks of the first portion of resource blocks. The UE 115-c may receive the first part of the PBCH and one or more first DMRSs of a set of DMRSs via a third set of resource blocks of the first portion of resource blocks.

At 1020, the UE 115-c may monitor a second subset of the set of resources for a second portion of resource blocks (e.g., the second portion of PRBs 215-b as described with reference to FIG. 2) of the SSB based on the capability of the UE. The first subset of the set of resources may be different from the second subset of the set of resources. The first subset of the set of resources may be allocated for one or more wireless devices having a different capability than the capability of the UE (e.g., a UE capability associated with the MTC UE 115-b). A first part of a PBCH may be mapped to the first subset of the set of resources and a second part of the PBCH is mapped to the second subset of the set of resources. For example, the non-MTC UE 115-a may monitor the second subset of the set of resources. The UE 115-c may receive the second part of the PBCH and one or more second DMRSs of the set of DMRSs via a fourth set of resource blocks of the second portion of resource blocks. The capability of the UE may include a second capability to monitor a channel bandwidth of at least 5 MHz.

In some cases, the UE 115-c may monitoring for the second portion of resource blocks with different mapping patterns based on a channel bandwidth associated with the set of resources. The mapping pattern may include at least a first mapping pattern mapping to frequency resource after an ending subcarrier of the first subset of the set of resources, a second mapping pattern mapping to second frequency resources before an initial subcarrier of the first subset of the set of resources, and a third mapping pattern mapping to third frequency resources after the ending subcarrier of the first subset of the set of resources and before the initial subcarrier of the first subset of the set of resources.

In some cases, the first portion of resource blocks may be associated with a first set of subcarriers, and the second portion of resource blocks may be associated with a second set of subcarriers corresponding to frequencies greater than the first set of subcarriers, as described with reference to FIG. 8. In some cases, the first portion of resource blocks may be associated with a first set of subcarriers, and the second portion of resource blocks may be associated with a second set of subcarriers corresponding to frequencies less than the first set of subcarriers, as described with reference to FIG. 7.

In some cases, the first portion of resource blocks may be associated with a first set of subcarriers, the second portion of resource blocks may be associated with a second set of subcarriers. The first set of subcarriers and the second set of subcarriers are a same set of subcarriers, as described with reference to FIG. 4. The first set of subcarriers and the second set of subcarriers are different set of subcarriers, as described with reference to FIGS. 6-9. In some cases, at least the first portion of resource blocks may be associated with a subcarrier spacing of 7.5 kHz, as described with reference to FIG. 5.

In some cases, the first portion of resource blocks may be associated with a first set of time resources, and the second portion of resource blocks may be associated with a second set of time resources. The first set of time resources and the second set of time resources may be different, as described with reference to FIG. 4.

The UE 115-c may monitoring a synchronization raster point, as described with reference to FIG. 3. Monitoring the first subset of the set of resources and the second subset of the set of resources may be based on monitoring the synchronization raster point. The UE 115-c may monitor a channel bandwidth with a channel raster of 100 kHz based on monitoring the synchronization raster point. The channel raster may be associated with the SSB.

In some cases, the UE 115-c may refrain from monitoring for a subset of the second set of subcarriers based on the subset of the second set of subcarriers being outside a channel bandwidth associated with the set of resources, as described with reference to FIG. 9.

At 1025, the UE 115-c may demap the SSB. The UE 115-c may demap the first part of the PBCH and the one or more first DMRSs based on the third set of resource blocks and the second part of the PBCH and the one or more second DMRSs based on the fourth set of resource blocks. The first part of the PBCH may be an initial part of the PBCH and the second part of the PBCH is a subsequent part of the PBCH.

The UE 115-c may performing resource element demapping based on a frequency first and time second mapping scheme. The UE 115-c may demap a first frequency-domain subcarrier for the first part of the PBCH and the one or more first DMRSs based on the third set of resource blocks. The first frequency-domain subcarrier may be counted relative to a first initial subcarrier of the third set of resource blocks. The UE 115-c may demap a first time-domain symbol, after demap the first frequency-domain subcarrier, for the first part of the PBCH and the one or more first DMRSs based on the third set of resource blocks. The UE 115-c may demap a second frequency-domain subcarrier for the second part of the PBCH and the one or more second DMRSs based on the fourth set of resource blocks. The second frequency-domain subcarrier may be counted relative to a second initial subcarrier of the fourth set of resource blocks. The UE 115-c may demap a second time-domain symbol, after demapping the second frequency-domain subcarrier, for the second part of the PBCH and the one or more second DMRSs based on the fourth set of resource blocks.

At 1030, the UE 115-c may decode system information associated with the SSB based on the first subset of the set of resources and the second subset of the set of resources.

At 1035, the UE 115-c may perform a cell acquisition procedure based on the system information.

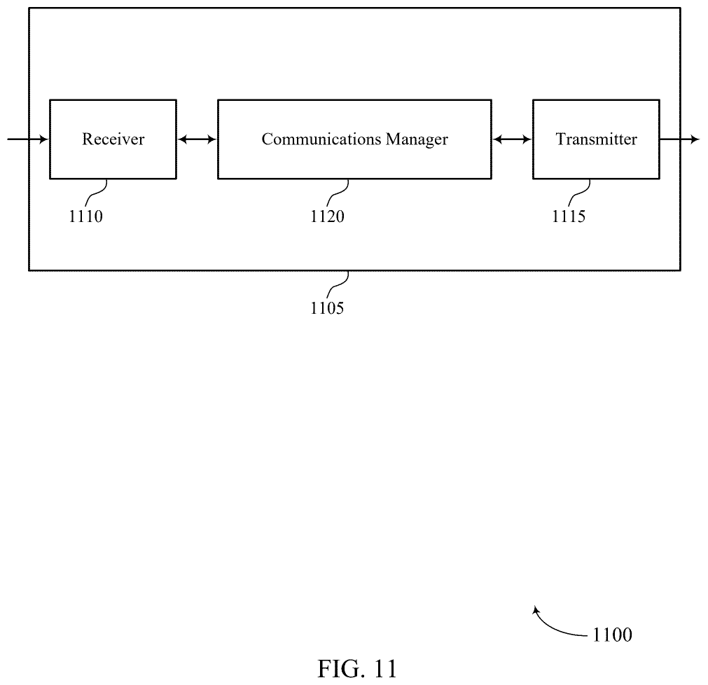

FIG. 11 shows a block diagram 1100 of a device 1105 that supports SSB design for MTC and non-MTC UEs in accordance with one or more aspects of the present disclosure. The device 1105 may be an example of aspects of a UE 115 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for receiving information such as packets, user data, control information, or any combination thereof associated with various information channels (e.g., control channels, data channels, information channels related to SSB design for MTC and non-MTC UEs). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to SSB design for MTC and non-MTC UEs). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations or components thereof may be examples of means for performing various aspects of SSB design for MTC and non-MTC UEs as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication in accordance with examples as disclosed herein. For example, the communications manager 1120 is capable of, configured to, or operable to support a means for monitoring a first subset of a set of resources for a first portion of resource blocks of a SSB based on a capability of the UE. The communications manager 1120 is capable of, configured to, or operable to support a means for monitoring a second subset of the set of resources for a second portion of resource blocks of the SSB based on the capability of the UE, where the first subset of the set of resources is different from the second subset of the set of resources, the first subset of the set of resources allocated for one or more wireless devices having a different capability than the capability of the UE, where a first part of a PBCH is mapped to the first subset of the set of resources and a second part of the PBCH is mapped to the second subset of the set of resources. The communications manager 1120 is capable of, configured to, or operable to support a means for decoding system information associated with the SSB based on the first subset of the set of resources and the second subset of the set of resources. The communications manager 1120 is capable of, configured to, or operable to support a means for performing a cell acquisition procedure based on the system information.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for more efficient utilization of communication resources and the like.

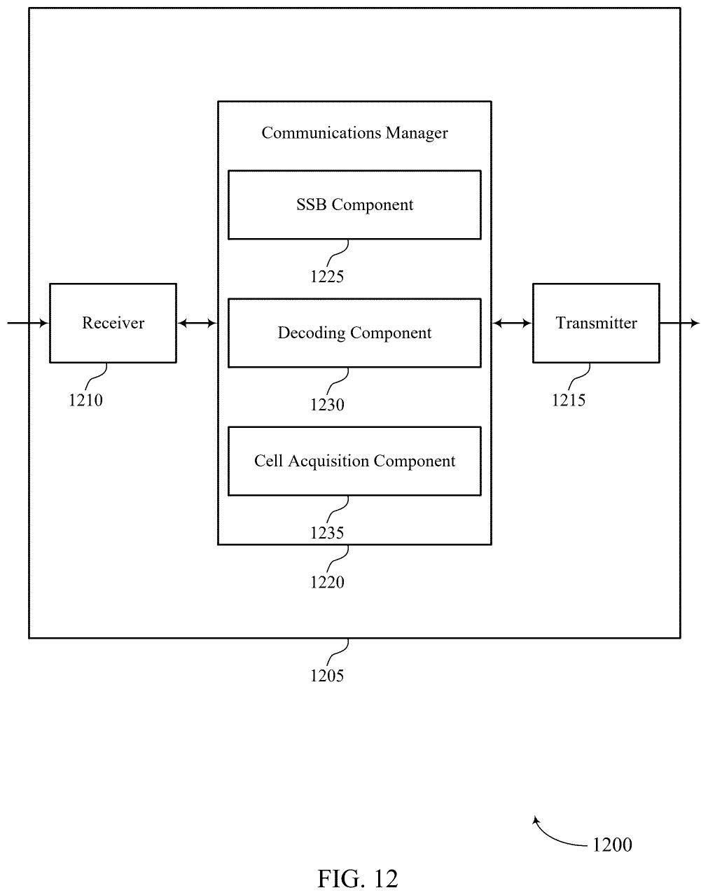

FIG. 12 shows a block diagram 1200 of a device 1205 that supports SSB design for MTC and non-MTC UEs in accordance with one or more aspects of the present disclosure. The device 1205 may be an example of aspects of a device 1105 or a UE 115 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for receiving information such as packets, user data, control information, or any combination thereof associated with various information channels (e.g., control channels, data channels, information channels related to SSB design for MTC and non-MTC UEs). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to SSB design for MTC and non-MTC UEs). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of SSB design for MTC and non-MTC UEs as described herein. For example, the communications manager 1220 may include an SSB component 1225, a decoding component 1230, a cell acquisition component 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication in accordance with examples as disclosed herein. The SSB component 1225 is capable of, configured to, or operable to support a means for monitoring a first subset of a set of resources for a first portion of resource blocks of a SSB based on a capability of the UE. The SSB component 1225 is capable of, configured to, or operable to support a means for monitoring a second subset of the set of resources for a second portion of resource blocks of the SSB based on the capability of the UE, where the first subset of the set of resources is different from the second subset of the set of resources, the first subset of the set of resources allocated for one or more wireless devices having a different capability than the capability of the UE, where a first part of a PBCH is mapped to the first subset of the set of resources and a second part of the PBCH is mapped to the second subset of the set of resources. The decoding component 1230 is capable of, configured to, or operable to support a means for decoding system information associated with the SSB based on the first subset of the set of resources and the second subset of the set of resources. The cell acquisition component 1235 is capable of, configured to, or operable to support a means for performing a cell acquisition procedure based on the system information.

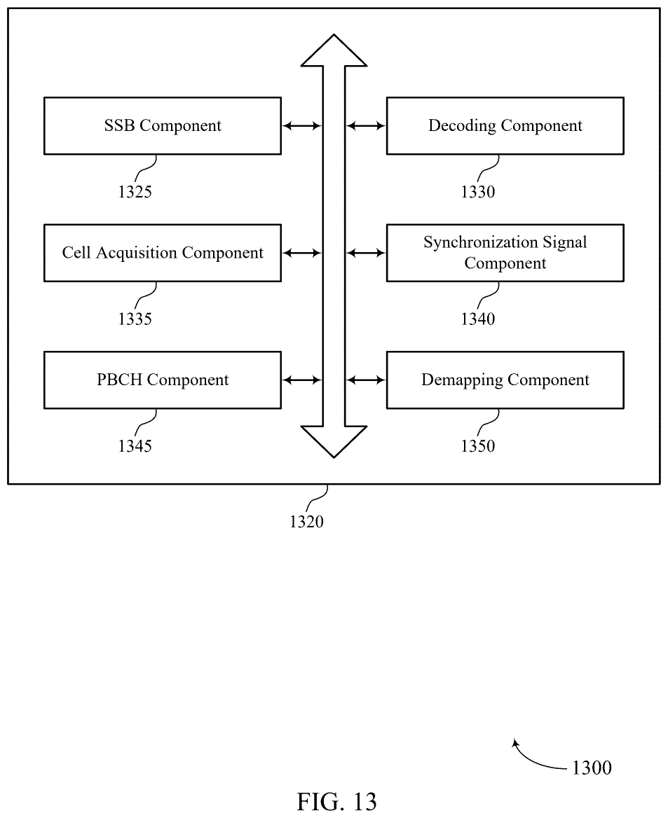

FIG. 13 shows a block diagram 1300 of a communications manager 1320 that supports SSB design for MTC and non-MTC UEs in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of SSB design for MTC and non-MTC UEs as described herein. For example, the communications manager 1320 may include an SSB component 1325, a decoding component 1330, a cell acquisition component 1335, a synchronization signal component 1340, a PBCH component 1345, a demapping component 1350, or any combination thereof. Each of these components, or components or subcomponents thereof (e.g., one or more processors, one or more memories), may communicate, directly or indirectly, with one another (e.g., via one or more buses).

The communications manager 1320 may support wireless communication in accordance with examples as disclosed herein. The SSB component 1325 is capable of, configured to, or operable to support a means for monitoring a first subset of a set of resources for a first portion of resource blocks of a SSB based on a capability of the UE. In some examples, the SSB component 1325 is capable of, configured to, or operable to support a means for monitoring a second subset of the set of resources for a second portion of resource blocks of the SSB based on the capability of the UE, where the first subset of the set of resources is different from the second subset of the set of resources, the first subset of the set of resources allocated for one or more wireless devices having a different capability than the capability of the UE, where a first part of a PBCH is mapped to the first subset of the set of resources and a second part of the PBCH is mapped to the second subset of the set of resources. The decoding component 1330 is capable of, configured to, or operable to support a means for decoding system information associated with the SSB based on the first subset of the set of resources and the second subset of the set of resources. The cell acquisition component 1335 is capable of, configured to, or operable to support a means for performing a cell acquisition procedure based on the system information.

In some examples, the SSB component 1325 is capable of, configured to, or operable to support a means for monitoring a synchronization raster point, where monitoring the first subset of the set of resources and the second subset of the set of resources is based on monitoring the synchronization raster point.

In some examples, the SSB component 1325 is capable of, configured to, or operable to support a means for monitoring a channel bandwidth with a channel raster of 100 kHz based on monitoring the synchronization raster point, where the channel raster is associated with the SSB.

In some examples, the synchronization signal component 1340 is capable of, configured to, or operable to support a means for receiving an PSS via a first set of multiple resource blocks of the first portion of resource blocks. In some examples, the synchronization signal component 1340 is capable of, configured to, or operable to support a means for receiving an SSS via a second set of multiple resource blocks of the first portion of resource blocks. In some examples, the PBCH component 1345 is capable of, configured to, or operable to support a means for receiving the first part of the PBCH and one or more first DMRSs of a set of DMRSs via a third set of multiple resource blocks of the first portion of resource blocks. In some examples, the PBCH component 1345 is capable of, configured to, or operable to support a means for receiving the second part of the PBCH and one or more second DMRSs of the set of DMRSs via a fourth set of multiple resource blocks of the second portion of resource blocks.

In some examples, the first set of multiple resource blocks, the second set of multiple resource blocks, and the third set of multiple resource blocks are associated with a first set of frequency resources, and the fourth set of multiple resource blocks are associated with a second set of frequency resources.

In some examples, the demapping component 1350 is capable of, configured to, or operable to support a means for demapping the first part of the PBCH and the one or more first DMRSs based on the third set of multiple resource blocks and the second part of the PBCH and the one or more second DMRSs based on the fourth set of multiple resource blocks, where the first part of the PBCH is an initial part of the PBCH and the second part of the PBCH is a subsequent part of the PBCH.

In some examples, the demapping component 1350 is capable of, configured to, or operable to support a means for demapping a first frequency-domain subcarrier for the first part of the PBCH and the one or more first DMRSs based on the third set of multiple resource blocks, where the first frequency-domain subcarrier is counted relative to a first initial subcarrier of the third set of multiple resource blocks. In some examples, the demapping component 1350 is capable of, configured to, or operable to support a means for demapping a first time-domain symbol, after demapping the first frequency-domain subcarrier, for the first part of the PBCH and the one or more first DMRSs based on the third set of multiple resource blocks. In some examples, the demapping component 1350 is capable of, configured to, or operable to support a means for demapping a second frequency-domain subcarrier for the second part of the PBCH and the one or more second DMRSs based on the fourth set of multiple resource blocks, where the second frequency-domain subcarrier is counted relative to a second initial subcarrier of the fourth set of multiple resource blocks. In some examples, the demapping component 1350 is capable of, configured to, or operable to support a means for demapping a second time-domain symbol, after demapping the second frequency-domain subcarrier, for the second part of the PBCH and the one or more second DMRSs based on the fourth set of multiple resource blocks.

In some examples, the first part of the PBCH and the second part of the PBCH are encoded using a same encoding scheme.

In some examples, the first part of the PBCH is encoded using a first RV and the second part of the PBCH is encoded using a second RV different from the first RV.

In some examples, the first portion of resource blocks is associated with a first set of subcarriers, the second portion of resource blocks is associated with a second set of subcarriers. In some examples, the first set of subcarriers and the second set of subcarriers are a same set of subcarriers.

In some examples, the first portion of resource blocks is associated with a first set of subcarriers, and the second portion of resource blocks is associated with a second set of subcarriers and. In some examples, the first set of subcarriers and the second set of subcarriers are different set of subcarriers.

In some examples, at least the first portion of resource blocks is associated with a subcarrier spacing of 7.5 kHz.

In some examples, the SSB component 1325 is capable of, configured to, or operable to support a means for refraining from monitoring for a subset of the second set of subcarriers based on the subset of the second set of subcarriers being outside a channel bandwidth associated with the set of resources.

In some examples, to support monitoring the second subset of the set of resources, the demapping component 1350 is capable of, configured to, or operable to support a means for monitoring for the second portion of resource blocks with different mapping patterns based on a channel bandwidth associated with the set of resources, where the mapping patterns include at least a first mapping pattern mapping to frequency resource after an ending subcarrier of the first subset of the set of resources, a second mapping pattern mapping to second frequency resources before an initial subcarrier of the first subset of the set of resources, and a third mapping pattern mapping to third frequency resources after the ending subcarrier of the first subset of the set of resources and before the initial subcarrier of the first subset of the set of resources.

In some examples, the demapping component 1350 is capable of, configured to, or operable to support a means for receiving, via a broadcast system information message, an indication of a mapping pattern for the second portion of resource blocks, where the mapping pattern is based on the channel bandwidth associated with the set of resources.

In some examples, the first portion of resource blocks is associated with a first set of time resources, the second portion of resource blocks is associated with a second set of time resources. In some examples, the first set of time resources and the second set of time resources are different.

In some examples, the first portion of resource blocks is associated with a first set of subcarriers, and the second portion of resource blocks is associated with a second set of subcarriers corresponding to frequencies greater than the first set of subcarriers.

In some examples, the first portion of resource blocks is associated with a first set of subcarriers, and the second portion of resource blocks is associated with a second set of subcarriers corresponding to frequencies less than the first set of subcarriers.

In some examples, the capability of the UE includes a second capability to monitor a channel bandwidth of at least 5 MHz.

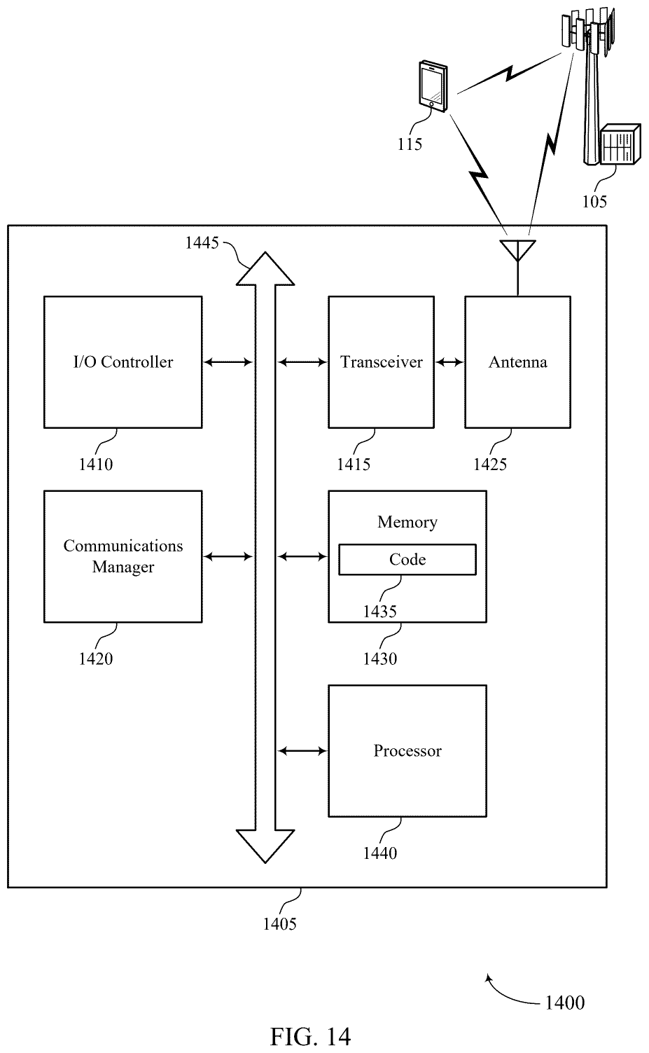

FIG. 14 shows a diagram of a system 1400 including a device 1405 that supports SSB design for MTC and non-MTC UEs in accordance with one or more aspects of the present disclosure. The device 1405 may be an example of or include components of a device 1105, a device 1205, or a UE 115 as described herein. The device 1405 may communicate (e.g., wirelessly) with one or more other devices (e.g., network entities 105, UEs 115, or a combination thereof). The device 1405 may include components for bi-directional voice and data communications including components for transmitting and receiving communications, such as a communications manager 1420, an input/output (I/O) controller, such as an I/O controller 1410, a transceiver 1415, one or more antennas 1425, at least one memory 1430, code 1435, and at least one processor 1440. These components may be in electronic communication or otherwise coupled (e.g., operatively, communicatively, functionally, electronically, electrically) via one or more buses (e.g., a bus 1445).

The I/O controller 1410 may manage input and output signals for the device 1405. The I/O controller 1410 may also manage peripherals not integrated into the device 1405. In some cases, the I/O controller 1410 may represent a physical connection or port to an external peripheral. In some cases, the I/O controller 1410 may utilize an operating system such as iOS®, ANDROID®, MS-DOS®, MS-WINDOWS®, OS/2®, UNIX®, LINUX®, or another known operating system. Additionally, or alternatively, the I/O controller 1410 may represent or interact with a modem, a keyboard, a mouse, a touchscreen, or a similar device. In some cases, the I/O controller 1410 may be implemented as part of one or more processors, such as the at least one processor 1440. In some cases, a user may interact with the device 1405 via the I/O controller 1410 or via hardware components controlled by the I/O controller 1410.

In some cases, the device 1405 may include a single antenna. However, in some other cases, the device 1405 may have more than one antenna, which may be capable of concurrently transmitting or receiving multiple wireless transmissions. The transceiver 1415 may communicate bi-directionally via the one or more antennas 1425 using wired or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The at least one memory 1430 may include random access memory (RAM) and read-only memory (ROM). The at least one memory 1430 may store computer-readable, computer-executable, or processor-executable code, such as the code 1435. The code 1435 may include instructions that, when executed by the at least one processor 1440, cause the device 1405 to perform various functions described herein. The code 1435 may be stored in a non-transitory computer-readable medium such as system memory or another type of memory. In some cases, the code 1435 may not be directly executable by the at least one processor 1440 but may cause a computer (e.g., when compiled and executed) to perform functions described herein. In some cases, the at least one memory 1430 may include, among other things, a basic I/O system (BIOS) which may control basic hardware or software operation such as the interaction with peripheral components or devices.

The at least one processor 1440 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1440 may be configured to operate a memory array using a memory controller. In some other cases, a memory controller may be integrated into the at least one processor 1440. The at least one processor 1440 may be configured to execute computer-readable instructions stored in a memory (e.g., the at least one memory 1430) to cause the device 1405 to perform various functions (e.g., functions or tasks supporting SSB design for MTC and non-MTC UEs). For example, the device 1405 or a component of the device 1405 may include at least one processor 1440 and at least one memory 1430 coupled with or to the at least one processor 1440, the at least one processor 1440 and the at least one memory 1430 configured to perform various functions described herein.

In some examples, the at least one processor 1440 may include multiple processors and the at least one memory 1430 may include multiple memories. One or more of the multiple processors may be coupled with one or more of the multiple memories, which may, individually or collectively, be configured to perform various functions described herein. In some examples, the at least one processor 1440 may be a component of a processing system, which may refer to a system (such as a series) of machines, circuitry (including, for example, one or both of processor circuitry (which may include the at least one processor 1440) and memory circuitry (which may include the at least one memory 1430)), or components, that receives or obtains inputs and processes the inputs to produce, generate, or obtain a set of outputs. The processing system may be configured to perform one or more of the functions described herein. For example, the at least one processor 1440 or a processing system including the at least one processor 1440 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code 1435 (e.g., processor-executable code) stored in the at least one memory 1430 or otherwise, to perform one or more of the functions described herein.

The communications manager 1420 may support wireless communication in accordance with examples as disclosed herein. For example, the communications manager 1420 is capable of, configured to, or operable to support a means for monitoring a first subset of a set of resources for a first portion of resource blocks of a SSB based on a capability of the UE. The communications manager 1420 is capable of, configured to, or operable to support a means for monitoring a second subset of the set of resources for a second portion of resource blocks of the SSB based on the capability of the UE, where the first subset of the set of resources is different from the second subset of the set of resources, the first subset of the set of resources allocated for one or more wireless devices having a different capability than the capability of the UE, where a first part of a PBCH is mapped to the first subset of the set of resources and a second part of the PBCH is mapped to the second subset of the set of resources. The communications manager 1420 is capable of, configured to, or operable to support a means for decoding system information associated with the SSB based on the first subset of the set of resources and the second subset of the set of resources. The communications manager 1420 is capable of, configured to, or operable to support a means for performing a cell acquisition procedure based on the system information.

By including or configuring the communications manager 1420 in accordance with examples as described herein, the device 1405 may support techniques for improved communication reliability, reduced latency, more efficient utilization of communication resources, and the like.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the at least one processor 1440, the at least one memory 1430, the code 1435, or any combination thereof. For example, the code 1435 may include instructions executable by the at least one processor 1440 to cause the device 1405 to perform various aspects of SSB design for MTC and non-MTC UEs as described herein, or the at least one processor 1440 and the at least one memory 1430 may be otherwise configured to, individually or collectively, perform or support such operations.

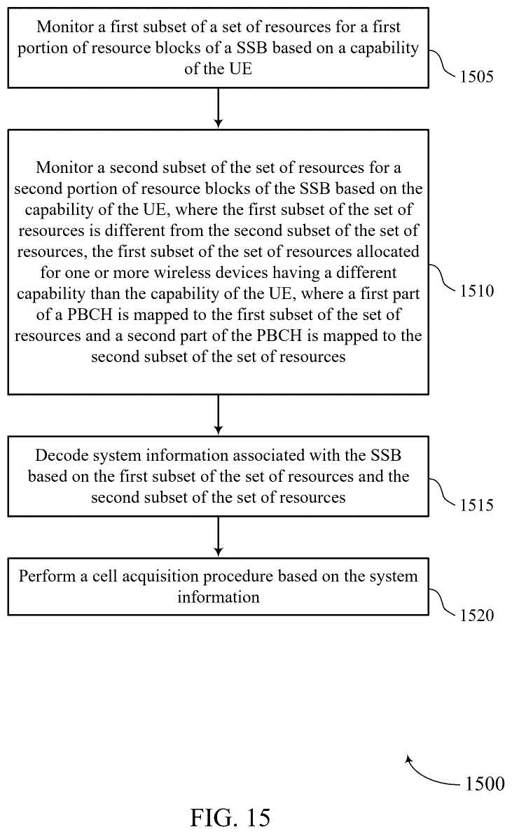

FIG. 15 shows a flowchart illustrating a method 1500 that supports SSB design for MTC and non-MTC UEs in accordance with one or more aspects of the present disclosure. The operations of the method 1500 may be implemented by a UE or its components as described herein. For example, the operations of the method 1500 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 1505, the method may include monitoring a first subset of a set of resources for a first portion of resource blocks of a SSB based on a capability of the UE. The operations of 1505 may be performed in accordance with examples as disclosed herein. In some examples, aspects of the operations of 1505 may be performed by an SSB component 1325 as described with reference to FIG. 13.

At 1510, the method may include monitoring a second subset of the set of resources for a second portion of resource blocks of the SSB based on the capability of the UE, where the first subset of the set of resources is different from the second subset of the set of resources, the first subset of the set of resources allocated for one or more wireless devices having a different capability than the capability of the UE, where a first part of a PBCH is mapped to the first subset of the set of resources and a second part of the PBCH is mapped to the second subset of the set of resources. The operations of 1510 may be performed in accordance with examples as disclosed herein. In some examples, aspects of the operations of 1510 may be performed by an SSB component 1325 as described with reference to FIG. 13.

At 1515, the method may include decoding system information associated with the SSB based on the first subset of the set of resources and the second subset of the set of resources. The operations of 1515 may be performed in accordance with examples as disclosed herein. In some examples, aspects of the operations of 1515 may be performed by a decoding component 1330 as described with reference to FIG. 13.

At 1520, the method may include performing a cell acquisition procedure based on the system information. The operations of 1520 may be performed in accordance with examples as disclosed herein. In some examples, aspects of the operations of 1520 may be performed by a cell acquisition component 1335 as described with reference to FIG. 13.

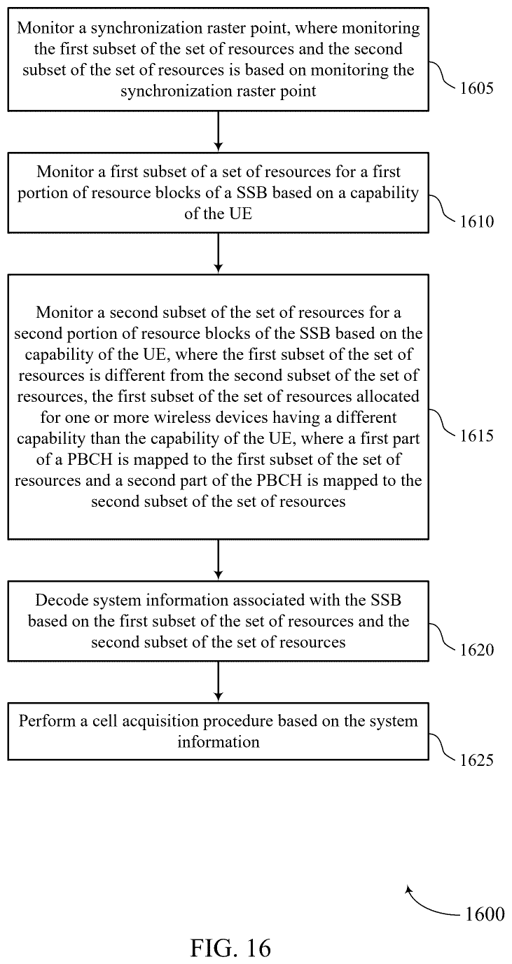

FIG. 16 shows a flowchart illustrating a method 1600 that supports SSB design for MTC and non-MTC UEs in accordance with one or more aspects of the present disclosure. The operations of the method 1600 may be implemented by a UE or its components as described herein. For example, the operations of the method 1600 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 1605, the method may include monitoring a synchronization raster point, where monitoring the first subset of the set of resources and the second subset of the set of resources is based on monitoring the synchronization raster point. The operations of 1605 may be performed in accordance with examples as disclosed herein. In some examples, aspects of the operations of 1605 may be performed by an SSB component 1325 as described with reference to FIG. 13.

At 1610, the method may include monitoring a first subset of a set of resources for a first portion of resource blocks of a SSB based on a capability of the UE. The operations of 1610 may be performed in accordance with examples as disclosed herein. In some examples, aspects of the operations of 1610 may be performed by an SSB component 1325 as described with reference to FIG. 13.

At 1615, the method may include monitoring a second subset of the set of resources for a second portion of resource blocks of the SSB based on the capability of the UE, where the first subset of the set of resources is different from the second subset of the set of resources, the first subset of the set of resources allocated for one or more wireless devices having a different capability than the capability of the UE, where a first part of a PBCH is mapped to the first subset of the set of resources and a second part of the PBCH is mapped to the second subset of the set of resources. The operations of 1615 may be performed in accordance with examples as disclosed herein. In some examples, aspects of the operations of 1615 may be performed by an SSB component 1325 as described with reference to FIG. 13.

At 1620, the method may include decoding system information associated with the SSB based on the first subset of the set of resources and the second subset of the set of resources. The operations of 1620 may be performed in accordance with examples as disclosed herein. In some examples, aspects of the operations of 1620 may be performed by a decoding component 1330 as described with reference to FIG. 13.

At 1625, the method may include performing a cell acquisition procedure based on the system information. The operations of 1625 may be performed in accordance with examples as disclosed herein. In some examples, aspects of the operations of 1625 may be performed by a cell acquisition component 1335 as described with reference to FIG. 13.

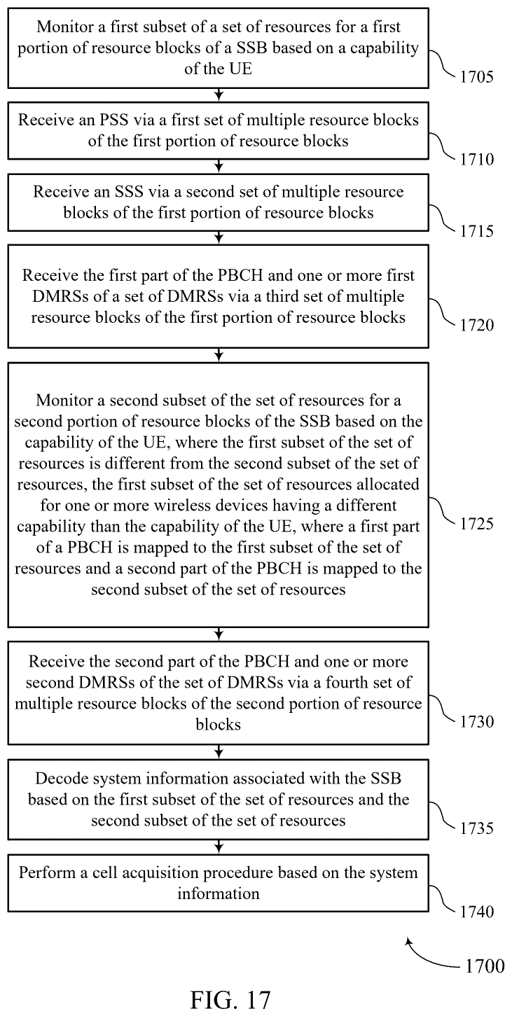

FIG. 17 shows a flowchart illustrating a method 1700 that supports SSB design for MTC and non-MTC UEs in accordance with one or more aspects of the present disclosure. The operations of the method 1700 may be implemented by a UE or its components as described herein. For example, the operations of the method 1700 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 1705, the method may include monitoring a first subset of a set of resources for a first portion of resource blocks of a SSB based on a capability of the UE. The operations of 1705 may be performed in accordance with examples as disclosed herein. In some examples, aspects of the operations of 1705 may be performed by an SSB component 1325 as described with reference to FIG. 13.

At 1710, the method may include receiving an PSS via a first set of multiple resource blocks of the first portion of resource blocks. The operations of 1710 may be performed in accordance with examples as disclosed herein. In some examples, aspects of the operations of 1710 may be performed by a synchronization signal component 1340 as described with reference to FIG. 13.

At 1715, the method may include receiving an SSS via a second set of multiple resource blocks of the first portion of resource blocks. The operations of 1715 may be performed in accordance with examples as disclosed herein. In some examples, aspects of the operations of 1715 may be performed by a synchronization signal component 1340 as described with reference to FIG. 13.

At 1720, the method may include receiving the first part of the PBCH and one or more first DMRSs of a set of DMRSs via a third set of multiple resource blocks of the first portion of resource blocks. The operations of 1720 may be performed in accordance with examples as disclosed herein. In some examples, aspects of the operations of 1720 may be performed by a PBCH component 1345 as described with reference to FIG. 13.

At 1725, the method may include monitoring a second subset of the set of resources for a second portion of resource blocks of the SSB based on the capability of the UE, where the first subset of the set of resources is different from the second subset of the set of resources, the first subset of the set of resources allocated for one or more wireless devices having a different capability than the capability of the UE, where a first part of a PBCH is mapped to the first subset of the set of resources and a second part of the PBCH is mapped to the second subset of the set of resources. The operations of 1725 may be performed in accordance with examples as disclosed herein. In some examples, aspects of the operations of 1725 may be performed by an SSB component 1325 as described with reference to FIG. 13.

At 1730, the method may include receiving the second part of the PBCH and one or more second DMRSs of the set of DMRSs via a fourth set of multiple resource blocks of the second portion of resource blocks. The operations of 1730 may be performed in accordance with examples as disclosed herein. In some examples, aspects of the operations of 1730 may be performed by a PBCH component 1345 as described with reference to FIG. 13.

At 1735, the method may include decoding system information associated with the SSB based on the first subset of the set of resources and the second subset of the set of resources. The operations of 1735 may be performed in accordance with examples as disclosed herein. In some examples, aspects of the operations of 1735 may be performed by a decoding component 1330 as described with reference to FIG. 13.

At 1740, the method may include performing a cell acquisition procedure based on the system information. The operations of 1740 may be performed in accordance with examples as disclosed herein. In some examples, aspects of the operations of 1740 may be performed by a cell acquisition component 1335 as described with reference to FIG. 13.

The following provides an overview of aspects of the present disclosure:

Aspect 1: A method for wireless communications at a UE, comprising: monitoring a first subset of a set of resources for a first portion of resource blocks of a SSB based at least in part on a capability of a UE; monitoring a second subset of the set of resources for a second portion of resource blocks of the SSB based at least in part on the capability of the UE, wherein the first subset of the set of resources is different from the second subset of the set of resources, the first subset of the set of resources allocated for one or more wireless devices having a different capability than the capability of the UE, wherein a first part of a PBCH is mapped to the first subset of the set of resources and a second part of the PBCH is mapped to the second subset of the set of resources; decode system information associating with the SSB based at least in part on the first subset of the set of resources and the second subset of the set of resources; and performing a cell acquisition procedure based at least in part on the system information.

Aspect 2: The method of aspect 1, further comprising: monitoring a synchronization raster point, wherein monitoring the first subset of the set of resources and the second subset of the set of resources is based at least in part on monitoring the synchronization raster point.

Aspect 3: The method of aspect 2, further comprising: monitoring a channel bandwidth with a channel raster of 100 kHz based at least in part on monitoring the synchronization raster point, wherein the channel raster is associated with the SSB.

Aspect 4: The method of any of aspects 1 through 3, further comprising: receiving an PSS via a first plurality of resource blocks of the first portion of resource blocks; receiving an SSS via a second plurality of resource blocks of the first portion of resource blocks; receiving the first part of the PBCH and one or more first DMRSs of a set of DMRSs via a third plurality of resource blocks of the first portion of resource blocks; and receiving the second part of the PBCH and one or more second DMRSs of the set of DMRSs via a fourth plurality of resource blocks of the second portion of resource blocks.

Aspect 5: The method of aspect 4, wherein the first plurality of resource blocks, the second plurality of resource blocks, and the third plurality of resource blocks are associated with a first set of frequency resources, and the fourth plurality of resource blocks are associated with a second set of frequency resources.

Aspect 6: The method of any of aspects 4 through 5, further comprising: demapping the first part of the PBCH and the one or more first DMRSs based at least in part on the third plurality of resource blocks and the second part of the PBCH and the one or more second DMRSs based at least in part on the fourth plurality of resource blocks, wherein the first part of the PBCH is an initial part of the PBCH and the second part of the PBCH is a subsequent part of the PBCH.

Aspect 7: The method of aspect 6, further comprising: demapping a first frequency-domain subcarrier for the first part of the PBCH and the one or more first DMRSs based at least in part on the third plurality of resource blocks, wherein the first frequency-domain subcarrier is counted relative to a first initial subcarrier of the third plurality of resource blocks; demapping a first time-domain symbol, after demapping the first frequency-domain subcarrier, for the first part of the PBCH and the one or more first DMRSs based at least in part on the third plurality of resource blocks; demapping a second frequency-domain subcarrier for the second part of the PBCH and the one or more second DMRSs based at least in part on the fourth plurality of resource blocks, wherein the second frequency-domain subcarrier is counted relative to a second initial subcarrier of the fourth plurality of resource blocks; and demapping a second time-domain symbol, after demapping the second frequency-domain subcarrier, for the second part of the PBCH and the one or more second DMRSs based at least in part on the fourth plurality of resource blocks.

Aspect 8: The method of any of aspects 4 through 7, wherein the first part of the PBCH and the second part of the PBCH are encoded using a same encoding scheme.

Aspect 9: The method of any of aspects 4 through 7, wherein the first part of the PBCH is encoded using a first RV and the second part of the PBCH is encoded using a second RV different from the first RV.

Aspect 10: The method of any of aspects 1 through 9, wherein the first portion of resource blocks is associated with a first set of subcarriers, the second portion of resource blocks is associated with a second set of subcarriers, and the first set of subcarriers and the second set of subcarriers are a same set of subcarriers.

Aspect 11: The method of any of aspects 1 through 9, wherein the first portion of resource blocks is associated with a first set of subcarriers, and the second portion of resource blocks is associated with a second set of subcarriers, and the first set of subcarriers and the second set of subcarriers are different set of subcarriers.

Aspect 12: The method of aspect 11, wherein at least the first portion of resource blocks is associated with a subcarrier spacing of 7.5 kHz.

Aspect 13: The method of any of aspects 11 through 12, further comprising: refrain from monitoring for a subset of the second set of subcarriers based at least in part on the subset of the second set of subcarriers being outside a channel bandwidth associated with the set of resources.

Aspect 14: The method of any of aspects 11 through 12, wherein to monitoring the second subset of the set of resources further comprises: monitoring for the second portion of resource blocks with different mapping patterns based at least in part on a channel bandwidth associated with the set of resources, wherein the mapping patterns include at least a first mapping pattern mapping to frequency resource after an ending subcarrier of the first subset of the set of resources, a second mapping pattern mapping to second frequency resources before an initial subcarrier of the first subset of the set of resources, and a third mapping pattern mapping to third frequency resources after the ending subcarrier of the first subset of the set of resources and before the initial subcarrier of the first subset of the set of resources.

Aspect 15: The method of aspect 14, further comprising: receiving, via a broadcast system information message, an indication of a mapping pattern for the second portion of resource blocks, wherein the mapping pattern is based at least in part on the channel bandwidth associated with the set of resources.

Aspect 16: The method of any of aspects 1 through 9, wherein the first portion of resource blocks is associated with a first set of time resources, the second portion of resource blocks is associated with a second set of time resources, and the first set of time resources and the second set of time resources are different.

Aspect 17: The method of any of aspects 1 through 9, wherein the first portion of resource blocks is associated with a first set of subcarriers, and the second portion of resource blocks is associated with a second set of subcarriers corresponding to frequencies greater than the first set of subcarriers.

Aspect 18: The method of any of aspects 1 through 9, wherein the first portion of resource blocks is associated with a first set of subcarriers, and the second portion of resource blocks is associated with a second set of subcarriers corresponding to frequencies less than the first set of subcarriers.

Aspect 19: A UE for wireless communications, comprising one or more memories storing processor-executable code, and one or more processors coupled with the one or more memories and individually or collectively operable to execute the code to cause the UE to perform a method of any of aspects 1 through 18.

Aspect 20: A UE for wireless communications, comprising at least one means for performing a method of any of aspects 1 through 18.

Aspect 21: A non-transitory computer-readable medium storing code for wireless communications, the code comprising instructions executable by one or more processors to perform a method of any of aspects 1 through 18.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
one or more memories storing processor-executable code; and
one or more processors coupled with the one or more memories and individually or collectively operable to execute the code to cause the apparatus to:
monitor a first subset of a set of resources for a first portion of resource blocks of a synchronization signal block (SSB) based at least in part on a capability of a user equipment (UE);
monitor a second subset of the set of resources for a second portion of resource blocks of the SSB based at least in part on the capability of the UE, wherein the first subset of the set of resources is different from the second subset of the set of resources, the first subset of the set of resources allocated for one or more wireless devices having a different capability than the capability of the UE, wherein a first part of a physical broadcast channel (PBCH) is mapped to the first subset of the set of resources and a second part of the PBCH is mapped to the second subset of the set of resources;
decode system information associated with the SSB based at least in part on the first subset of the set of resources and the second subset of the set of resources; and
perform a cell acquisition procedure based at least in part on the system information.

2. The apparatus of claim 1, wherein the one or more processors are individually or collectively further operable to execute the code to cause the apparatus to:
monitor a synchronization raster point, wherein monitoring the first subset of the set of resources and the second subset of the set of resources is based at least in part on monitoring the synchronization raster point.

3. The apparatus of claim 2, wherein the one or more processors are individually or collectively further operable to execute the code to cause the apparatus to:
monitor a channel bandwidth with a channel raster of 100 kilohertz (kHz) based at least in part on monitoring the synchronization raster point, wherein the channel raster is associated with the SSB.

4. The apparatus of claim 1, wherein the one or more processors are individually or collectively further operable to execute the code to cause the apparatus to:
receive a primary synchronization signal (PSS) via a first plurality of resource blocks of the first portion of resource blocks;
receive a secondary synchronization signal (SSS) via a second plurality of resource blocks of the first portion of resource blocks;
receive the first part of the PBCH and one or more first demodulation reference signals (DMRSs) of a set of DMRSs via a third plurality of resource blocks of the first portion of resource blocks; and
receive the second part of the PBCH and one or more second DMRSs of the set of DMRSs via a fourth plurality of resource blocks of the second portion of resource blocks.

5. The apparatus of claim 4, wherein the first plurality of resource blocks, the second plurality of resource blocks, and the third plurality of resource blocks are associated with a first set of frequency resources, and the fourth plurality of resource blocks are associated with a second set of frequency resources.

6. The apparatus of claim 4, wherein the one or more processors are individually or collectively further operable to execute the code to cause the apparatus to:
demap the first part of the PBCH and the one or more first DMRSs based at least in part on the third plurality of resource blocks and the second part of the PBCH and the one or more second DMRSs based at least in part on the fourth plurality of resource blocks, wherein the first part of the PBCH is an initial part of the PBCH and the second part of the PBCH is a subsequent part of the PBCH.

7. The apparatus of claim 6, wherein the one or more processors are individually or collectively further operable to execute the code to cause the apparatus to:
demap a first frequency-domain subcarrier for the first part of the PBCH and the one or more first DMRSs based at least in part on the third plurality of resource blocks, wherein the first frequency-domain subcarrier is counted relative to a first initial subcarrier of the third plurality of resource blocks;
demap a first time-domain symbol, after demapping the first frequency-domain subcarrier, for the first part of the PBCH and the one or more first DMRSs based at least in part on the third plurality of resource blocks;
demap a second frequency-domain subcarrier for the second part of the PBCH and the one or more second DMRSs based at least in part on the fourth plurality of resource blocks, wherein the second frequency-domain subcarrier is counted relative to a second initial subcarrier of the fourth plurality of resource blocks; and
demap a second time-domain symbol, after demapping the second frequency-domain subcarrier, for the second part of the PBCH and the one or more second DMRSs based at least in part on the fourth plurality of resource blocks.

8. The apparatus of claim 4, wherein the first part of the PBCH and the second part of the PBCH are encoded using a same encoding scheme.

9. The apparatus of claim 4, wherein the first part of the PBCH is encoded using a first redundancy version and the second part of the PBCH is encoded using a second redundancy version different from the first redundancy version.

10. The apparatus of claim 1, wherein:
the first portion of resource blocks is associated with a first set of subcarriers, the second portion of resource blocks is associated with a second set of subcarriers, and
the first set of subcarriers and the second set of subcarriers are a same set of subcarriers.

11. The apparatus of claim 1, wherein the first portion of resource blocks is associated with a first set of subcarriers, and the second portion of resource blocks is associated with a second set of subcarriers, and the first set of subcarriers and the second set of subcarriers are different set of subcarriers.

12. The apparatus of claim 11, wherein at least the first portion of resource blocks is associated with a subcarrier spacing of 7.5 kHz.

13. The apparatus of claim 11, wherein the one or more processors are individually or collectively further operable to execute the code to cause the apparatus to:
refrain from monitoring for a subset of the second set of subcarriers based at least in part on the subset of the second set of subcarriers being outside a channel bandwidth associated with the set of resources.

14. The apparatus of claim 11, wherein, to monitor the second subset of the set of resources, the one or more processors are individually or collectively further operable to execute the code to cause the apparatus to:
monitor for the second portion of resource blocks with different mapping patterns based at least in part on a channel bandwidth associated with the set of resources, wherein the mapping patterns include at least a first mapping pattern mapping to frequency resource after an ending subcarrier of the first subset of the set of resources, a second mapping pattern mapping to second frequency resources before an initial subcarrier of the first subset of the set of resources, and a third mapping pattern mapping to third frequency resources after the ending subcarrier of the first subset of the set of resources and before the initial subcarrier of the first subset of the set of resources.

15. The apparatus of claim 14, wherein the one or more processors are individually or collectively further operable to execute the code to cause the apparatus to:
receive, via a broadcast system information message, an indication of a mapping pattern for the second portion of resource blocks, wherein the mapping pattern is based at least in part on the channel bandwidth associated with the set of resources.

16. The apparatus of claim 1, wherein:
the first portion of resource blocks is associated with a first set of time resources, the second portion of resource blocks is associated with a second set of time resources, and
the first set of time resources and the second set of time resources are different.

17. The apparatus of claim 1, wherein the first portion of resource blocks is associated with a first set of subcarriers, and the second portion of resource blocks is associated with a second set of subcarriers corresponding to frequencies greater than the first set of subcarriers.

18. The apparatus of claim 1, wherein the first portion of resource blocks is associated with a first set of subcarriers, and the second portion of resource blocks is associated with a second set of subcarriers corresponding to frequencies less than the first set of subcarriers.

19. A method for wireless communication at a user equipment (UE) comprising:
monitoring a first subset of a set of resources for a first portion of resource blocks of a synchronization signal block (SSB) based at least in part on a capability of the UE;
monitoring a second subset of the set of resources for a second portion of resource blocks of the SSB based at least in part on the capability of the UE, wherein the first subset of the set of resources is different from the second subset of the set of resources, the first subset of the set of resources allocated for one or more wireless devices having a different capability than the capability of the UE, wherein a first part of a physical broadcast channel (PBCH) is mapped to the first subset of the set of resources and a second part of the PBCH is mapped to the second subset of the set of resources;
decoding system information associated with the SSB based at least in part on the first subset of the set of resources and the second subset of the set of resources; and
performing a cell acquisition procedure based at least in part on the system information.

20. A non-transitory computer-readable medium storing code for wireless communication, the code comprising instructions executable by one or more processors to:
monitor a first subset of a set of resources for a first portion of resource blocks of a synchronization signal block (SSB) based at least in part on a capability of a user equipment (UE);
monitor a second subset of the set of resources for a second portion of resource blocks of the SSB based at least in part on the capability of the UE, wherein the first subset of the set of resources is different from the second subset of the set of resources, the first subset of the set of resources allocated for one or more wireless devices having a different capability than the capability of the UE, wherein a first part of a physical broadcast channel (PBCH) is mapped to the first subset of the set of resources and a second part of the PBCH is mapped to the second subset of the set of resources;
decode system information associated with the SSB based at least in part on the first subset of the set of resources and the second subset of the set of resources; and
perform a cell acquisition procedure based at least in part on the system information.
